(19) United States
(12) Patent Application Publication
(10) Pub. No.: US 2015/0219336 A1
(43) Pub. Date: Aug. 6, 2015

(54) SYSTEMS AND METHODS FOR REDUCING MODAL COUPLING OF COMBUSTION DYNAMICS

(71) Applicant: General Electric Company, Schenectady, NY (US)

(72) Inventors: Sarah Lori Crothers, Greenville, SC (US); Willy Steve Ziminsky, Greeville, SC (US); Christian Xavier Stevenson, Blanchester, OH (US)

(73) Assignee: General Electric Company, Schenectady, NY (US)

(21) Appl. No.: 14/170,729

(22) Filed: Feb. 3, 2014

(51) Int. Cl. F23R 3/34; F02C 3/14

(52) U.S. Cl. CPC F23R 3/34; F02C 3/14; F05D 2240/35; F05D 2220/32

(57) ABSTRACT

A gas turbine includes one or more combustors, and each combustor may include one or more fuel nozzles for mixing fuel with a compressed working fluid prior to combustion. The gas turbine further includes various structures for reducing the modal coupling of the combustion dynamics by producing a different convective time, fuel flow, and/or compressed working fluid flow through at least one fuel nozzle.

### TECHNICAL FIELD

The present disclosure is generally directed to a gas turbine. Specifically, the gas turbine or other turbomachine provided herein may include features that, either alone or in combination, reduce modal coupling of combustion dynamics.

### BACKGROUND

Combustors are commonly used in industrial and commercial operations to ignite fuel to produce combustion gases having a high temperature and pressure. For example, gas turbines and other turbo-machines typically include one or more combustors to generate power or thrust. A typical gas turbine used to generate electrical power includes an axial compressor at the front, multiple combustors around the middle, and a turbine at the rear. Ambient air enters the compressor as a working fluid, and the compressor progressively imparts kinetic energy to the working fluid to produce a compressed working fluid at a highly energized state. The compressed working fluid exits the compressor and flows through one or more fuel nozzles and/or tubes in the combustors where the compressed working fluid mixes with fuel before igniting to generate combustion gases having a high temperature and pressure. The combustion gases flow to the turbine where they expand to produce work. For example, expansion of the combustion gases in the turbine may rotate a shaft connected to a generator to produce electricity.

Combustion dynamics can result from the interaction of one or more acoustic modes of a combustor and the heat release fluctuations inherent in the combustion process. For example, acoustic pressure pulsations may cause a mass flow fluctuation at a fuel port, which then results in a fuel-air ratio fluctuation in the combustion flame. If the resulting fuel/air ratio fluctuation and the acoustic pressure pulsations have a certain phase behavior (e.g., approximately in-phase), a self-excited feedback loop may result. The combustion dynamics resulting from this, as well as other mechanisms, may reduce the useful life of the combustors. For example, the combustion dynamics may produce pressure pulsations inside the fuel nozzles and/or combustion chambers that may adversely affect the high cycle fatigue life of these components, the stability of the combustion flame, the design margins for flame holding, and/or undesirable emissions.

In addition, at particular operating conditions, combustion dynamics at specific frequencies and with sufficient amplitudes, which are in phase and coherent, may produce undesirable sympathetic vibrations in the turbine and/or other downstream components. In the context of this disclosure, “coherence” refers to the strength of the linear relationship between two (or more) dynamic signals, which is strongly influenced by the degree of frequency overlap between them. Typically, this problem of unwanted vibrations in downstream components that may result from in-phase, coherent combustion tones is managed by combustor tuning that limits the amplitude of the combustion dynamics in a particular frequency band. However, combustor tuning may unnecessarily limit the operating range of the combustor.

As an alternative to combustor tuning, reducing the coherence and, therefore, modal coupling of combustion dynamics may also reduce unwanted vibrations in downstream components. For instance, altering the frequency relationship between two or more combustors may reduce the coherence of the combustion system as a whole, diminishing any combustor-to-combustor coupling. As the combustion dynamics frequency in one combustor is driven away from that of the other combustors, modal coupling of combustion dynamics is reduced, which, in turn, reduces the ability of the combustor tone to cause a vibratory response in downstream components. An alternate method of reducing modal coupling is to reduce the constructive interference of the fuel nozzles within the same combustor, reducing the amplitudes in each combustor, and preventing or reducing combustor-to-combustor coupling.

Therefore, a gas turbine that reduces the modal coupling of combustion dynamics by altering the frequency difference between two or more combustors would be useful for enhancing the thermodynamic efficiency of the combustors, protecting against accelerated wear, promoting flame stability, and/or reducing undesirable emissions over a wide range of operating levels, without detrimentally impacting the life of the downstream hot gas path components.

### SUMMARY

Aspects and advantages of the invention are set forth below in the following description, or may be obvious from the description, or may be learned through practice of the invention.

The various embodiments of the present disclosure are directed to a gas turbine that includes a compressor section; a turbine section; and first and second combustors arranged about an axis between the compressor section and the turbine section. Each combustor includes a cap assembly that extends radially across at least a portion of the combustor, at least one fuel nozzle (or fuel nozzle group) that provides fluid communication through the cap assembly, and a liner that defines a combustion chamber downstream from the fuel nozzles. Each fuel nozzle includes a fuel port that provides fluid communication from the fuel nozzle into the combustion chamber. The fuel port is located at an axial distance from the combustion chamber.

In a first embodiment, the system includes a primary fuel circuit having a primary fuel manifold and a number of fuel supply lines extending from the manifold to the fuel nozzle groups. A first fuel supply line extends to the primary fuel nozzle group of the first combustor, while a second fuel supply line extends to the primary fuel nozzle group of the second combustor. A first primary orifice plate, which defines a first effective area, is disposed within the first fuel supply line upstream from the primary fuel nozzle group in the first combustor. A second primary orifice plate, which defines a second effective area substantially different from the first effective area, is disposed within the second fuel supply line upstream from the primary fuel nozzle group in the second combustor. Further, the fuel port of the fuel nozzles in the primary fuel nozzle group in the first combustor is located at a first axial distance from the combustion chamber, and the fuel port of the fuel nozzles in the primary fuel nozzle group in the second combustor is located at a second axial distance from the combustor chamber, the second axial distance being substantially different from the first axial distance.

In another embodiment, the system includes a primary fuel circuit having a primary fuel manifold and a number of fuel supply lines extending from the manifold to the fuel nozzle groups. A first fuel supply line extends to the primary fuel nozzle group of the first combustor, while a second fuel supply line extends to the primary fuel nozzle group of the second combustor. A first primary orifice plate, which defines a first effective area, is disposed within the first fuel supply line upstream from the primary fuel nozzle group in the first combustor. A second primary orifice plate, which defines a second effective area substantially different from the first effective area, is disposed within the second fuel supply line upstream from the primary fuel nozzle group in the second combustor. Further, the combustors include at least one fuel injector located downstream of the primary fuel nozzles and an outer sleeve at least partially surrounding the liner and defining therethrough a set of flow openings. The effective cross-sectional area of the fuel injector in the second combustor is larger than the effective cross-sectional area of the fuel injector in the first combustor, while the collective effective area of the set of flow openings in the first combustor is larger than the collective effective area of the set of flow openings in the second combustor.

In yet another embodiment, the fuel nozzle of the primary fuel nozzle group in each combustor includes a center body having a diameter and an axial length, a burner tube circumferentially surrounding at least a portion of the axial length of the center body, and a fuel port that provides fluid communication from the fuel nozzle into the combustion chamber. The center body defines a center body diameter, and the burner tube defines a burner tube inner diameter. At least one of the center body diameter and the burner tube inner diameter in the first combustor is substantially different, along at least a portion of the length thereof, from the respective center body diameter and burner tube inner diameter in the second combustor.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simplified cross-section view of an exemplary gas turbine, according to the present disclosure;

FIG. 2 is a simplified side cross-sectional view of an exemplary combustor, according to aspects of the present disclosure;

FIG. 3 is an upstream plan view of a cap assembly of the combustor shown in FIG. 2, according to a first aspect of the present disclosure:

FIG. 4 is an upstream plan view of an alternate cap assembly of the combustor shown in FIG. 2, according to a second aspect of the present disclosure;

FIG. 5 is an upstream plan view of yet another cap assembly of the combustor shown in FIG. 2, according to a third aspect of the present disclosure;

FIG. 6 is a side cross-sectional view of the cap assembly shown in FIG. 3 taken along line A-A, according to an aspect of the present disclosure;

FIG. 7 is a side cross-sectional view of the cap assembly shown in FIG. 5 taken along line B-B, according to an alternate aspect of the present disclosure;

FIG. 8 is a side cross-sectional view of the combustion section of the gas turbine shown in FIG. 1, according to certain aspects of the present disclosure;

FIG. 9 is a side cross-sectional view of the combustion section of the gas turbine shown in FIG. 1, according to an alternate aspect of the present disclosure;

FIG. 10 is a side cross-sectional view of the combustion section of the gas turbine shown in FIG. 1, according to further aspects of the present disclosure;

FIG. 11 is a side cross-sectional view of the combustion section of the gas turbine shown in FIG. 1, according to still further aspects of the present disclosure;

FIG. 12 is an upstream plan view of a cap assembly of the combustor shown in FIG. 2, according to an aspect of the present disclosure;

FIG. 13 is an upstream plan view of an alternate cap assembly of the combustor shown in FIG. 2, according to an alternate aspect of the present disclosure;

FIG. 14 is an upstream plan view of a cap assembly of the combustor shown in FIG. 2, according to a further aspect of the present disclosure;

FIG. 15 is an upstream plan view of a combustion section of the gas turbine shown in FIG. 1, according to a still further aspect of the present disclosure;

FIG. 16 is an upstream plan view of an alternate combustion section of the gas turbine shown in FIG. 1, according to another aspect of the present disclosure;

FIG. 17 is an upstream plan view of a combustion section of the gas turbine of FIG. 1, according to yet another aspect of the present disclosure;

FIG. 18 is a side cross-sectional view of an exemplary fuel injector, shown in FIG. 2;

FIG. 19 is a simplified side cross-sectional view of a combustion section of the gas turbine shown in FIG. 1, according to an aspect of the present disclosure;

FIG. 20 is a simplified side cross-sectional view of a combustion section of the gas turbine shown in FIG. 1, according to another aspect of the present disclosure; and

FIG. 21 is a schematic diagram of a system for reducing modal coupling of combustion dynamics using orifice plates, according to yet another of the present disclosure.

### DETAILED DESCRIPTION

Reference will now be made in detail to various embodiments of the present invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first,” “second,” “third,” and the like may be used interchangeably to distinguish one component from another and are not intended to signify location or importance of the individual components. Similarly, the terms “primary,” “secondary,” and “tertiary” may be used to distinguish one component from another and are not intended to signify location or importance of the individual components.

The terms “upstream,” “downstream,” “radially,” and “axially” refer to the relative direction with respect to fluid flow in a fluid pathway. For example, “upstream” refers to the direction from which the fluid flows (e.g., through the fuel nozzles), and “downstream” refers to the direction to which the fluid flows (e.g., toward the turbine section). Similarly, “radially” refers to the relative direction substantially perpendicular to the fluid flow, and “axially” refers to the relative direction substantially parallel to the fluid flow.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The present disclosure presents various embodiments of systems and methods for reducing modal coupling of combustion dynamics. The systems and methods may be implemented in a gas turbine having multiple combustors, and each combustor may include one or more fuel nozzles axially aligned with a combustion chamber so that the fuel nozzles may mix fuel with a compressed working fluid (e.g., air) prior to combustion. The system and method may further include one or more fuel injectors downstream from the fuel nozzles that provide fluid communication through a liner that circumferentially surrounds each combustion chamber.

The gas turbine may include one or more different mechanisms for reducing coherence and, therefore, the modal coupling of the combustion dynamics, including mechanisms that produce a different convective time, fuel flow, and/or compressed working fluid flow through at least one fuel nozzle or fuel injector. As a result, the frequency relationship between two or more combustors may be altered to reduce the coherence of the combustion system as a whole and to diminish any combustor-to-combustor coupling. This frequency disruption may reduce the ability of the combustor tone to cause a vibratory response in downstream components and may also encourage destructive interference from combustor-to-combustor, reducing the amplitudes of the combustion dynamics. In some instances, two or more mechanisms for reducing coherence may be used in conjunction with one another.

Although exemplary embodiments of the present invention will be described generally in the context of combustion dynamics in a gas turbine for purposes of illustration, one of ordinary skill in the art will readily appreciate that embodiments of the present invention may be applied to any combustion dynamics and are not limited to a gas turbine unless specifically recited in the claims.

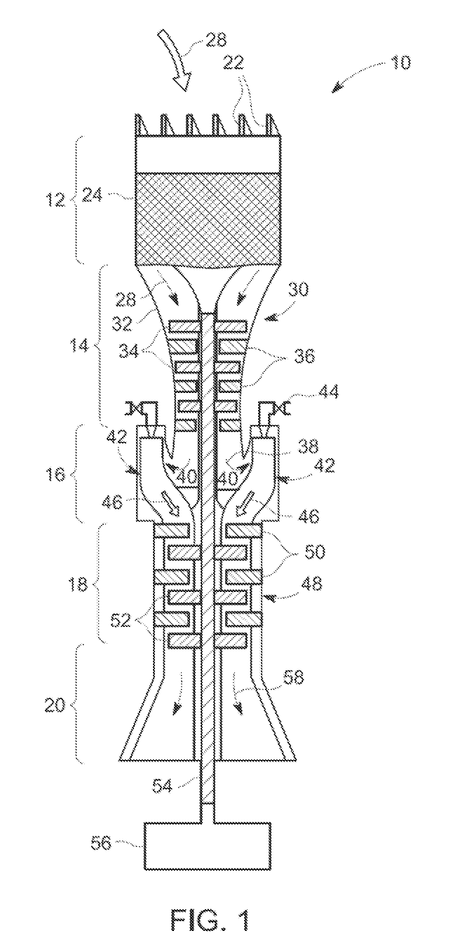

Referring now to the drawings, wherein identical numerals indicate the same elements throughout the Figures, FIG. 1 provides a simplified side cross-sectional view of an exemplary gas turbine 10 that may incorporate various embodiments of the present invention. As shown, the gas turbine 10 may generally include an inlet section 12, a compressor section 14, a combustion section 16, a turbine section 18, and an exhaust section 20. The inlet section 12 may include a series of filters 22 and one or more fluid conditioning devices 24 to clean, heat, cool, moisturize, demoisturize, and/or otherwise condition a working fluid (e.g., air) 28 entering the gas turbine 10. The cleaned and conditioned working fluid 28 flows to a compressor 30 in the compressor section 14. A compressor casing 32 contains the working fluid 28 as alternating stages of rotating blades 34 and stationary vanes 36 progressively accelerate and redirect the working fluid 28 to produce a continuous flow of compressed working fluid 38 at a higher temperature and pressure.

The majority of the compressed working fluid 38 flows through a compressor discharge plenum 40 to one or more combustors 42 in the combustion section 16, two of which are illustrated. The combustors 42 may be any type of combustor known in the art, and the present invention is not limited to any particular combustor design. The number of combustors 42 may vary. The combustors 42 are arranged circumferentially about a shaft 54, such that the inlet ends of the combustors 42 are co-planar and the outlet ends of the combustors 42 are co-planar. Said differently, the combustors 42 are “axially aligned,” in that the combustors 42 occupy the same axial position along the longitudinal axis of the turbine (represented by the shaft 54).

A fuel supply 44 in fluid communication with each combustor 42 supplies a fuel to each combustor 42. Possible fuels may include, for example, blast furnace gas, coke oven gas, natural gas, methane, vaporized liquefied natural gas (LNG), hydrogen, syngas, butane, propane, olefins, diesel, petroleum distillates, and combinations thereof. The compressed working fluid 38 mixes with the fuel and ignites to generate combustion gases 46 having a high temperature and pressure.

The combustion gases 46 flow along a hot gas path through a turbine 48 in the turbine section 18 where they expand to produce work. Specifically, the combustion gases 46 may flow across alternating stages of stationary nozzles 50 and rotating buckets 52 in the turbine 48. The stationary nozzles 50 redirect the combustion gases 46 onto the next stage of rotating buckets 52, and the combustion gases 46 expand as they pass over the rotating buckets 52, causing the rotating buckets 52 to rotate. The rotating buckets 52 are connected to the shaft 54, which is coupled to the compressor 30 such that rotation of the shaft 54 drives the compressor 30 to produce the compressed working fluid 38. Alternately or in addition, the shaft 54 may connect to a generator 56 for producing electricity. Exhaust gases 58 from the turbine section 18 flow through the exhaust section 20 prior to release to the environment.

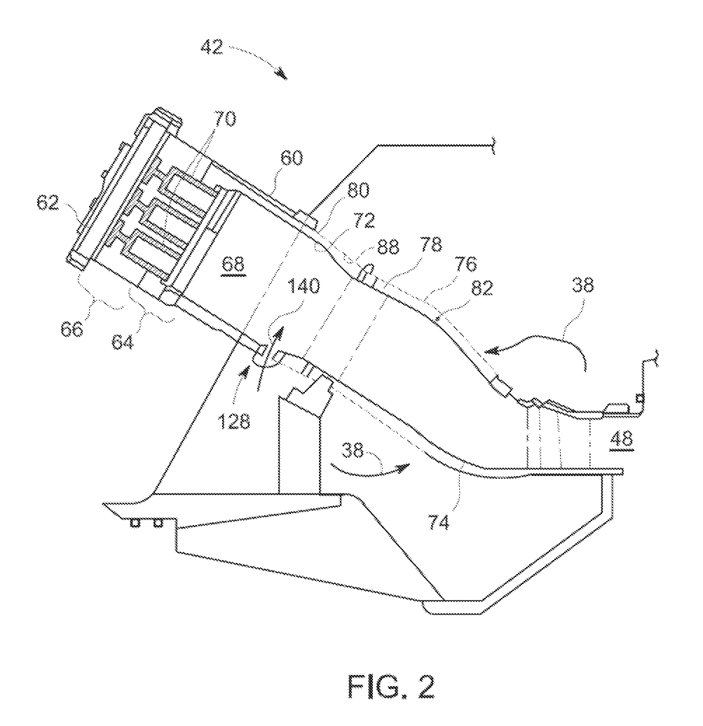

FIG. 2 provides a simplified side cross-sectional view of an exemplary combustor 42 according to various embodiments provided herein. As shown in FIG. 2, a combustor casing 60 and an end cover 62 may combine to contain the compressed working fluid 38 flowing to the combustor 42. A cap assembly 64 may extend radially across at least a portion of the combustor 42 to separate a head end 66 of the combustor from a combustion chamber 68 downstream from the cap assembly 64. One or more fuel nozzles 70 may be radially arranged across the cap assembly 64 to supply a mixture of fuel and compressed working fluid 38 from the head end 66 to the combustion chamber 68.

A liner 72 circumferentially surrounds at least a portion of the combustion chamber 68, and a transition duct 74 downstream from the liner 72 may connect the combustion chamber 68 to the inlet of the turbine 48. Alternately, the liner 72 and the transition duct 74 may be provided as a single, unitary component. A flow sleeve 80 may circumferentially surround the liner 72, defining an annular passage between the flow sleeve 80 and the liner 72 at the upstream end of the combustor 42. Similarly, an impingement sleeve 76 may circumferentially surround the transition duct 74, defining an annular passage between the impingement sleeve 76 and the transition duct 74 at the downstream end of the combustor 42. One or both of the flow sleeve 80 and the impingement sleeve 76 may be considered an “outer sleeve.” The respective upstream and downstream annular passages are fluidly connected to one another, such that an annular passage 82 is defined radially outward of the liner 72 and the transition duct 74 and extends a majority of the length of the combustor 42.

The compressed working fluid 38 may pass through a number of flow openings 78 located in the outer sleeve (i.e., the impingement sleeve 76 and/or flow sleeve 80) and into the annular passage 82. The flow openings 78 may be circular, slots, and/or other shapes and may direct the working fluid flow through the impingement sleeve 76 or flow sleeve 80 in a perpendicular direction relative to the impingement sleeve 76 or flow sleeve 80, or at some other angle. Further, the flow openings 78 may be of different sizes and/or of different numbers. The “collective effective area” of the flow openings 78 is the combined area through which the working fluid 38 can pass and may be calculated as the total (or sum) cross-sectional area of the flow openings 78 multiplied by the coefficient of flow. The coefficient of flow is the ratio of the actual and theoretical maximum flows through the flow openings 78.

The compressed working fluid 38 cools the surface of the transition duct 74 and the liner 72, as it travels in the upstream direction toward the end cover 62. When the compressed working fluid 38 reaches the end cover 62, the compressed working fluid 38 reverses direction to flow through the fuel nozzles 70, where it is introduced with fuel into the combustion chamber 68.

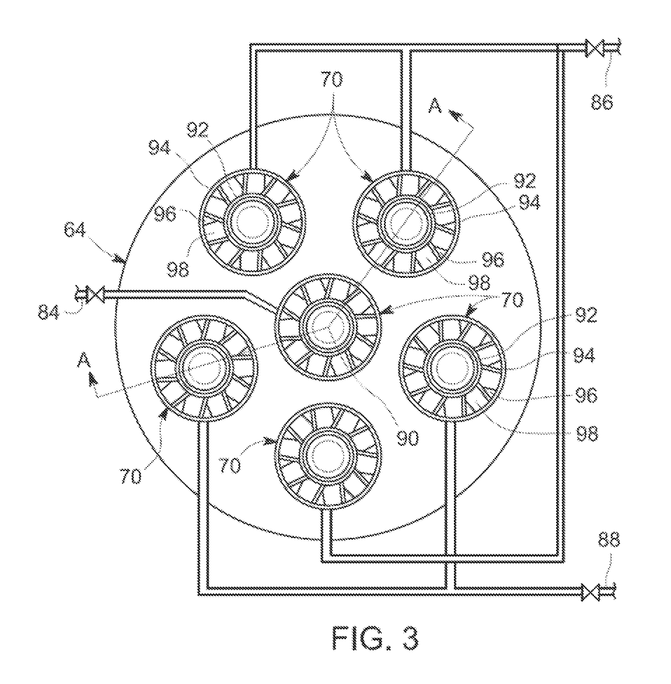

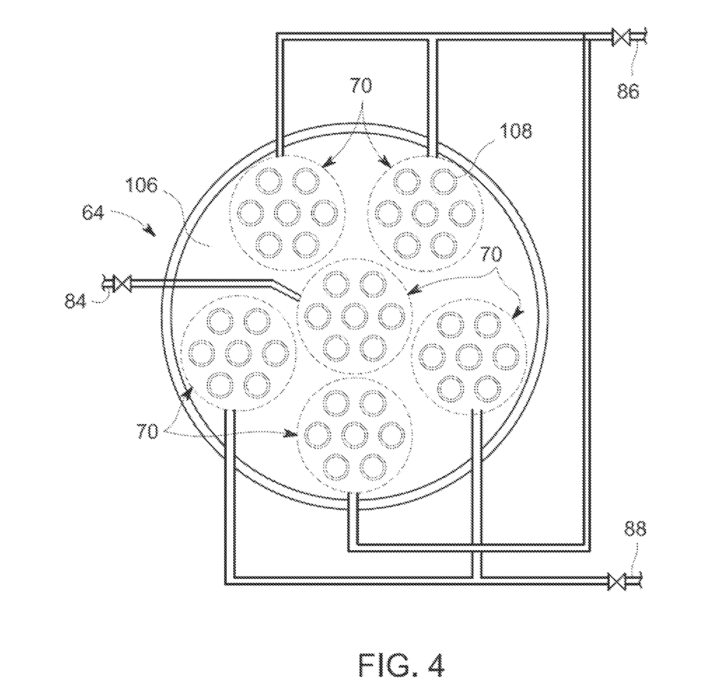

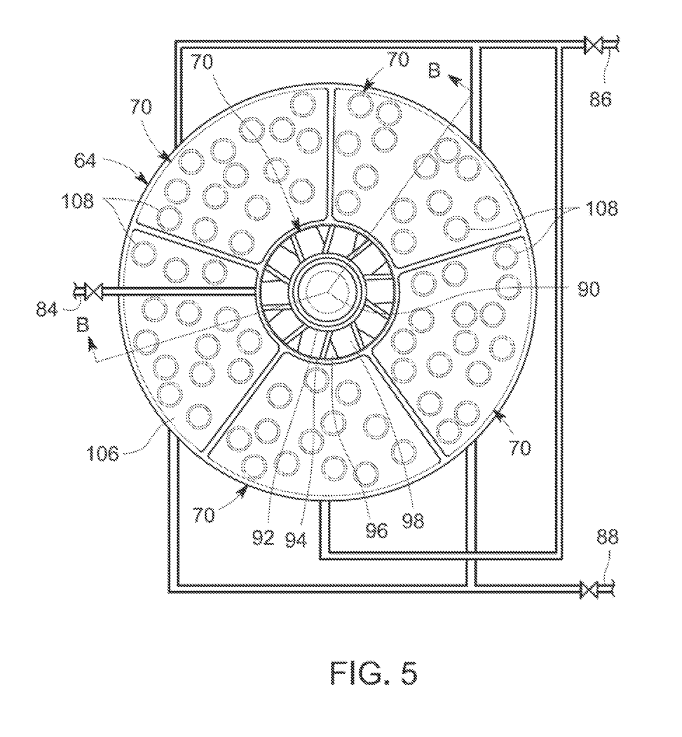

Although generally shown as cylindrical, the radial cross-section of the fuel nozzles 70 may be any geometric shape, and the present invention is not limited to any particular radial cross-section. In addition, various embodiments of the combustor 42 may include different numbers and arrangements of fuel nozzles 70 in the cap assembly 64, and FIGS. 3-5 provide upstream plan views of exemplary arrangements of the fuel nozzles 70 in the cap assembly 64. As shown in FIGS. 3 and 4, for example, multiple fuel nozzles 70 may be radially arranged around a single fuel nozzle 70. In FIG. 3, all of the fuel nozzles 70 are defined by a center body and swirl vanes. In FIG. 4, the fuel nozzles 70 may be categorized as tube bundles, in which a plurality of tubes is grouped together with a common fuel plenum to define a discreet nozzle. Alternately, as shown in FIG. 5, a round center nozzle 70 (such as that shown in FIG. 3) is circumferentially surrounded by tube-bundle nozzles 70 (such as those shown in FIG. 4), each of the tube-bundles nozzles having a truncated pie-shape.

By way of example and not limitation, the center tube bundle nozzle 70 shown in FIG. 4 may be replaced by the center fuel nozzle 70 shown in FIG. 3 to create another variation of the configurations shown in FIGS. 3-5. One of ordinary skill in the art will readily appreciate multiple other shapes and arrangements for the fuel nozzles 70 from the teachings herein, and the particular shape and arrangement of the fuel nozzles 70 are not limitations of the present invention unless specifically recited in the claims.

Within each combustor, the fuel nozzles 70 may be arranged in groups of one or more fuel nozzles 70, which will be referred to herein as a “primary fuel nozzle group”, a “secondary fuel nozzle group,” and a “tertiary fuel nozzle group.” These designations are provided wholly to facilitate a discussion of the relative groups and in no way should be interpreted as imparting greater (or lesser) importance to any particular group.

In the exemplary configurations shown in FIGS. 3-5, one group (e.g., a primary fuel nozzle group) may include only the center fuel nozzle 70, another group (e.g., a secondary fuel nozzle group) may include two fuel nozzles 70 radially outward of the center nozzle, and a third group (e.g., a tertiary fuel nozzle group) may include three fuel nozzles 70 radially outward of the center fuel nozzle 70. The secondary and tertiary fuel nozzle groups, as shown in FIGS. 3-5, collectively comprise the “outer” fuel nozzles 70. These groups are provided for illustrative purposes only, and it should be understood that the principles described herein may be applied to combustors 42 having different numbers of fuel nozzles 70 and different groupings of fuel nozzles 70, including combustors 42 having only a primary fuel nozzle group and a secondary fuel nozzle group.

The fuel nozzle groupings 70 may be arranged to facilitate multiple fueling regimes over the range of operations. For example, in the exemplary arrangements shown in FIGS. 3-5, the center fuel nozzle 70 may receive fuel from a primary fuel circuit 84, while the surrounding fuel nozzles 70 may be grouped to receive the same or a different fuel from a secondary and/or tertiary fuel circuit 88, 86. The fuel flow through each fuel circuit 84, 86, 88 is controlled by a gas control valve.

During base load operations, fuel may be supplied to each fuel nozzle 70 shown in FIGS. 3-5 through all three fuel circuits 84, 86, 88, while fuel flow may be reduced or completely eliminated from the center fuel nozzle 70 and/or one or more circumferentially arranged fuel nozzles 70 during reduced or turndown operations. Furthermore, the relative fuel flow in each fuel circuit 84, 86, 88 (also known as the “fuel split”) may be varied at a given operating condition, while maintaining constant total fuel flow, by repositioning each of the gas control valves. Altering the fuel split to one or more fuel circuits 84, 86, 88 in one or more combustors 42 may alter the frequency and/or amplitude of the combustion dynamics, and as a result may also alter the coherence of the combustion dynamics.

An overlap between the frequency of the combustion dynamics and the downstream component resonant frequency may result in unwanted vibration of the downstream components when an in-phase and coherent relationship between the combustion dynamics of two or more combustors 42 exists. The present disclosure includes various mechanisms for reducing the coherence or modal coupling of the combustion dynamics produced by the combustors 42 to reduce unwanted vibrations in hot gas path components downstream from the combustion section 16. In particular embodiments, the mechanisms may include structures for varying the flow of fuel and/or compressed working fluid 38 through the head end 66 of the combustors 42 and/or for varying the convective time between two or more fuel nozzles 70 within the same combustor 42 or between two or more combustors 42. As used herein, “convective time” (often represented by the Greek letter Tau) refers to the period of time between when the fuel is injected through the fuel nozzles 70 and when the fuel reaches the combustion chamber 68 and ignites. Therefore, convective time is a function of both the amount of the airflow through the head end 66, as well as the axial distance from the fuel injection location to the flame zone.

Of specific interest for the purposes described herein is the resulting relationship between combustion dynamics frequency and the convective time. Generally, there is an inverse relationship between convective time and frequency: that is, when the convective time increases, the frequency of the combustion instabilities decreases; and when the convective time decreases, the frequency of the combustion instabilities increases. A shift in the convective time in one or more combustors causes a shift in the combustion dynamic frequency of the one or more combustors away from that of the other combustors. Consequently, the coherence and, therefore, modal coupling of the combustors 42 may be reduced. In this manner, the present systems and methods may reduce unwanted vibrations in hot gas path components downstream from the combustion section 16 over a wide range of operating levels.

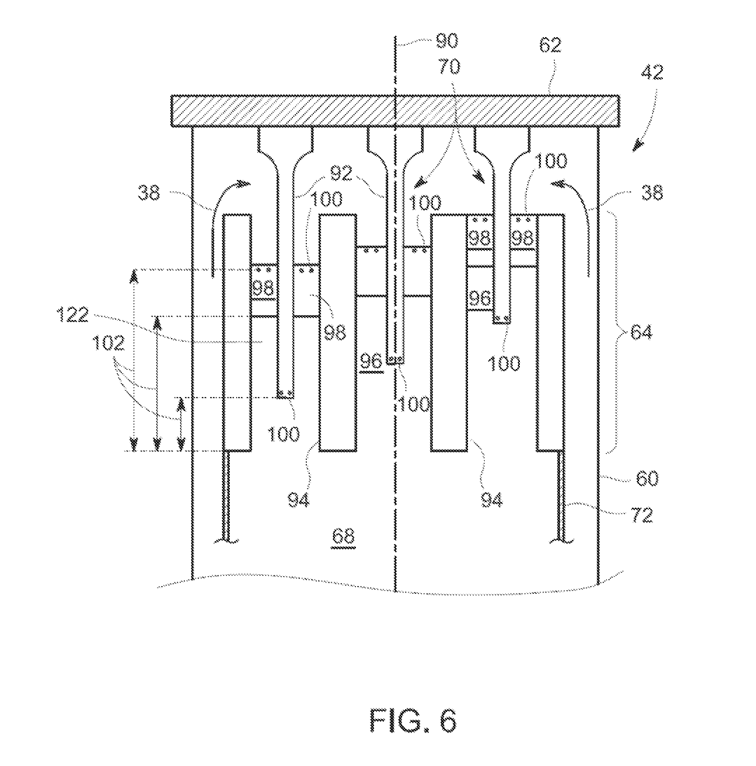

FIG. 6 provides a side cross-sectional view of the cap assembly 64 shown in FIG. 3 taken along line A-A, according to one aspect of the present disclosure. As shown in FIGS. 3 and 6, the combustor 42 may include five fuel nozzles 70 radially arranged around a center fuel nozzle 70 that is substantially aligned with an axial centerline 90 of the combustor 42. Each fuel nozzle 70 may include a center body 92 that extends axially downstream from the end cover 62 and a burner tube 94 that circumferentially surrounds at least a portion of the center body 92 to define an annular passage 96 between the center body 92 and the burner tube 94. The burner tube 94 may include a cylindrical portion extending downstream from the vanes, as well as a smaller cylindrical portion radially outward of the vanes. As used herein, the term “burner tube” is intended to refer to a structure incorporating the shroud. The burner tube 94 may be formed as a single cylindrical component or may be multiple components joined together to produce a component of the desired length.

The annular passage 96 defined as the space between the center body 92 and the burner tube 94 has an effective area 122. The effective area 122 may be defined as the net area through which the compressed working fluid 38 can pass through the fuel nozzle 70 and may be calculated as the total minimum cross-sectional area in the fuel nozzle 70 multiplied by the coefficient of flow. The coefficient of flow is the ratio of the actual and theoretical maximum flows through the fuel nozzle 70.

One or more swirler vanes 98 may extend radially between the center body 92 and the burner tube 94, and the swirler vanes 98 may be angled or curved to impart swirl to the compressed working fluid 38 flowing through the annular passage 96 between the center body 92 and the burner tube 94. As is conventionally understood, the swirler vanes 98 have leading edges and trailing edges. The swirler vanes 98 and/or the center body 92 may include one or more fuel ports 100. The fuel ports 100 provide fluid communication for the fuel to flow through the center body 92 and/or swirler vanes 98 into the annular passage 96, where the fuel mixes with the compressed working fluid 38 upstream of the combustion chamber 68. The fuel/air mixture is then combusted in the combustion chamber 68 to produce combustion gases 46.

The combustion process in the combustion chamber 68 (as seen in FIG. 2) may produce heat release fluctuations that may couple with one or more acoustic modes of the combustor 42, generating high levels of combustion dynamics. One specific mechanism that may produce excessive combustion dynamics occurs when the acoustic pulsations driven by the heat release fluctuations cause mass flow fluctuations through the fuel ports 100. For example, the pressure pulses associated with the combustion flames may propagate upstream from the combustion chamber 68 into each annular passage 96. Once the pressure pulses reach the fuel ports 100 of the center body 92 and/or swirler vanes 98, the pressure pulses may interfere with the fuel flow through the fuel ports 100 of the center body 92 and/or over the swirler vanes 98, creating fluctuations in the fuel-air mixture concentration flowing downstream toward the combustion flame. This fuel/air ratio fluctuation then travels downstream to the flame region where it causes a heat release fluctuation. Provided the resulting heat release fluctuation is approximately in phase with the pressure fluctuations, it will further encourage heat release fluctuations, creating a continuous feedback loop. The time for one cycle of the feedback loop is the convective time.

As previously discussed, the resulting combustion dynamics frequencies will be, at least in part, a function of the convective times for the fuel nozzles 70 and, therefore, will be dependent, in part, on the axial distances from the fuel port(s) 100 of the center body 92, the fuel port(s) 100 of the swirler vanes 98, and/or the leading edge of the swirler vanes 98 to the flame zone in the combustion chamber 68 (i.e., the end of the burner tubes 94). These resulting combustion dynamics frequencies may be adjusted and/or tuned in one or more fuel nozzles 70 to affect the combustion dynamics associated with the entire combustor 42.

In the particular embodiment shown in FIGS. 3 and 6, for example, the coherence and, therefore, the modal coupling of the combustion dynamics is reduced by adjusting the convective time in the individual fuel nozzles 70 within the same combustor 42. For each fuel nozzle 70, the swirler vanes 98 define one or more fuel ports 100 at a first axial distance from the combustion chamber. A second axial distance is defined between the leading edge of the swirler vanes 98 and the combustion chamber 68. The center body 92 defines one or more fuel ports 100 located at a third axial distance from the combustion chamber 38. Collectively, the first, second, and third axial distances are identified herein as “102.”

As shown in FIG. 6, the first, second, and the third axial distances 102 are substantially different for at least one of the fuel nozzles 70 associated with each of the primary, secondary, and tertiary fuel circuits within one of the combustors 42. The different axial distances 102 produce corresponding different convective times. That is, the combustion dynamics frequency generated by one or more fuel nozzles 70 is different from the frequencies generated by the other fuel nozzles 70, thereby reducing or precluding constructive interference between the fuel nozzles 70, which may in turn reduce the amplitude of the combustion dynamics associated with the particular combustor 42. Reducing the amplitude sufficiently may reduce the coherence and, therefore, the modal coupling of the combustion dynamics in the combustors 42.

The constructive and potentially destructive interference between the fuel nozzles 70 depends on the combination of convective times of the individual fuel nozzles 70 within the combustor 42. Such interference also affects the frequency of the resulting combustion dynamics in any one combustor 42.

One of ordinary skill in the art will readily appreciate that multiple combinations of variations in the axial distances 102 between the combustion chamber and one or more of the the swirler vanes 98, the fuel ports 100 in the swirler vanes 98, and the fuel ports 100 in the center body 92 are possible to achieve a desired combustion dynamics frequency for each fuel nozzle 70 and/or desired combustion dynamics for the particular combustor 42. For example, in particular embodiments, the axial distances 102 between the fuel ports 100 and/or the swirler vanes 98 and the combustion chamber 68 may be substantially the same or substantially different for some or all of the fuel nozzles 70 in a particular combustor 42, and the present invention is not limited to any particular combination of axial distances 102 unless specifically recited in the claims.

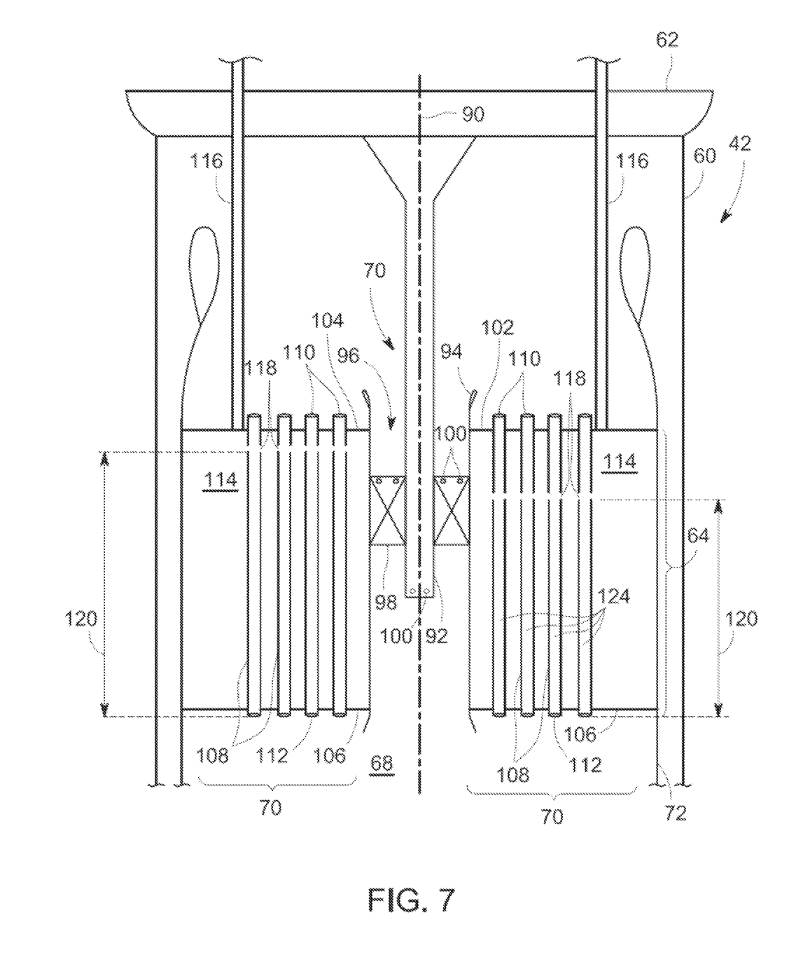

FIG. 7 provides a side cross-sectional view of the cap assembly 64 shown in FIG. 5 taken along line B-B, according to another aspect of the present disclosure. As shown, the cap assembly 64 extends radially across at least a portion of the combustor 42 and includes an upstream surface 104 axially separated from a downstream surface 106. The upstream and downstream surfaces 104, 106 may be generally flat or straight and oriented perpendicular to the general flow of the compressed working fluid 38 through the cap assembly 64.

In the particular variation shown in FIG. 7, the center fuel nozzle 70 is again substantially aligned with the axial centerline 90 of the cap assembly 64 and extends through the cap assembly 64 to provide fluid communication through the cap assembly 64 to the combustion chamber 68. The center fuel nozzle 70 may include any suitable structure known to one of ordinary skill in the art for mixing fuel with the compressed working fluid 38 prior to entry into the combustion chamber 68 and is not limited to any particular structure or design. For example, as shown in FIG. 7, the center fuel nozzle 70 may include the center body 92, burner tube 94, annular passage 96, swirler vanes 98, and fuel ports 100 as previously described with respect to the fuel nozzles 70 shown in FIG. 6.

As shown in FIGS. 5 and 7, the truncated pie-shaped fuel nozzles 70 may include a plurality of tubes 108 that extend from the upstream surface 104 through the downstream surface 106 of the cap assembly 64. Each tube 108 generally includes an inlet 110 proximate to the upstream surface 104 and an outlet 112 proximate to the downstream surface 106 to provide fluid communication through the cap assembly 64 and into the combustion chamber 68 downstream from the tubes 108. The tubes 108 define a cumulative effective area 122, defined as the net area through which the compressed working fluid 38 can pass through the fuel nozzle 70 and calculated as the total minimum cross-sectional area in the fuel nozzle 70 multiplied by the coefficient of flow. The coefficient of flow is the ratio of the actual and theoretical maximum flows through the fuel nozzle 70.

The upstream and downstream surfaces 104, 106 may at least partially define a fuel plenum 114 inside the cap assembly 64. A fuel conduit 116 may extend from the casing 60 and/or the end cover 62 through the upstream surface 104 to provide fluid communication for fuel to flow into the fuel plenum 114. One or more of the tubes 108 may include a fuel port 118 that extends through the tubes 108 to provide fluid communication from the fuel plenum 114 into the tubes 108. The fuel ports 118 may be angled radially, axially, and/or azimuthally to project and/or impart swirl to the fuel flowing through the fuel ports 118 and into the tubes 108. In some aspects, the fuel ports 118 of each tube 108 may be perpendicular to a longitudinal axis of the tube 108. One or more fuel ports 118 may be used for each tube 108.

The compressed working fluid 38 (e.g., air or oxidant) flows into the tube inlets 110, and fuel from the fuel conduit 116 may flow into the fuel plenum 114 around the tubes 108 to provide convective cooling to the tubes 108 before flowing through the fuel ports 118 and into the tubes 108 to mix with the compressed working fluid 38. The mixture of fuel and working fluid then flows through the tube outlets 112 and into the combustion chamber 68.

Incorporating tube-bundle nozzles 70 into the combustor 42, instead of or in addition to the swirler-type nozzles 70, results in similar combustion dynamics challenges. As described above, the combustion process in the combustion chamber 68 may produce heat release fluctuations that may couple with one or more acoustic modes of the combustor 42, generating the combustion dynamics. One specific mechanism by which the combustion dynamics may be produced occurs when the acoustic pulsations driven by the heat release fluctuations travel upstream to the fuel ports 118. The acoustic pulsations may interfere with the fuel flow through the fuel ports 118 and create fluctuations in the concentration of the fuel/working fluid mixture that is flowing downstream toward the combustion flame. This fluctuation in the fuel/working fluid ratio travels downstream to the flame region where it can cause a heat release fluctuation. Provided the resulting heat release fluctuation is approximately in-phase with the pressure fluctuations, it will further encourage heat release fluctuations, completing a continuous feedback loop. The time for one cycle of the feedback loop is the convective time.

As previously discussed, the resulting combustion dynamics frequencies will be, at least in part, a function of the convective times for the tubes 108 and, therefore, will be dependent, in part, on the axial distances from the fuel port(s) 118 to the flame zone in the combustion chamber 68 (i.e., the tube outlets 112). The resulting combustion dynamics frequencies may be adjusted and/or tuned in one or more tubes 108 and/or fuel nozzles 70 to affect the combustion dynamics associated with the individual combustor 42.

In the particular embodiment shown in FIGS. 5 and 7, for example, the coherence and, therefore, the modal coupling of the combustion dynamics is reduced by adjusting the convective time in the individual fuel nozzles 70 within the same combustor 42.

For each fuel nozzle 70 shown in FIGS. 4, 5, and 7, the tubes 108 define one or more fuel ports 100 at a fourth axial distance 120 from the combustion chamber 38 (in this case, the outlet ends 112 of the tubes 108). As shown in FIG. 7, the fourth axial distance 120 for one fuel nozzle 70 is substantially different from the fourth axial distance 120 of another fuel nozzle 70. The different axial distances 120 produce corresponding different convective times for each fuel nozzle 70. That is, the combustion dynamics frequency generated by one or more fuel nozzles 70 is different from the frequencies generated by the other fuel nozzles 70, thereby reducing or precluding constructive interference between the fuel nozzles 70, which may in turn reduce the amplitude of the combustion dynamics associated with the particular combustor 42. Reducing the amplitude sufficiently may reduce the coherence and, therefore, the modal coupling of the combustion dynamics in the combustors 42.

The constructive and potentially destructive interference between the fuel nozzles 70 depends on the combination of convective times of the individual fuel nozzles 70 within the combustor 42. Such interference affects the frequency of the resulting combustion dynamics in any one combustor 42.

One of ordinary skill in the art will readily appreciate from the teachings herein that multiple combinations of variations in the axial distances 120 between the fuel ports 118 and the combustion chamber 68 are possible to achieve a desired combustion dynamics frequency for each fuel nozzle 70 and/or desired combustion dynamics for the particular combustor 42. For example, in particular embodiments, the axial distances 120 between the fuel ports 118 and the combustion chamber 68 may be substantially the same or substantially different for some or all of the tubes 108 in a particular combustor 42, and the present invention is not limited to any particular combination of axial distances 120 unless specifically recited in the claims.

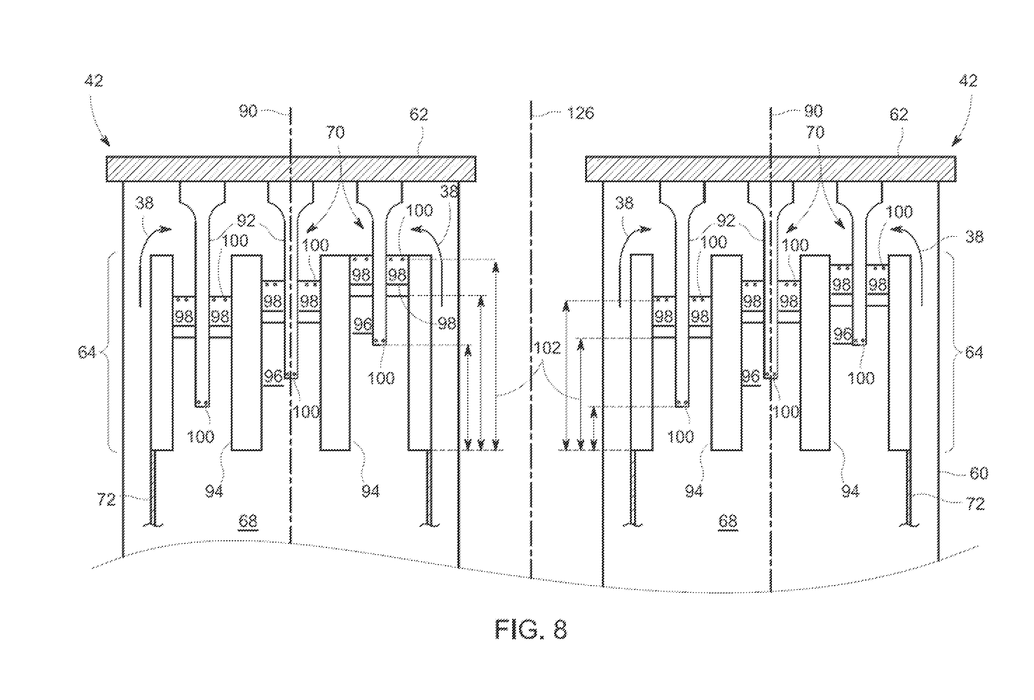

The combustion dynamics associated with multiple combustors 42 incorporated into the gas turbine 10 may either constructively or destructively interfere with one another to increase or decrease the amplitude and/or coherence of the combustion dynamics associated with the gas turbine 10. FIGS. 8-11 illustrate various embodiments in which one or more of the structures shown in FIGS. 6 and 7 may be incorporated into one or more combustors 42 to adjust and/or tune the convective times in the combustors 42 to decouple the interaction of the combustion dynamics between multiple combustors 42 in the same gas turbine 10. As the combustion dynamics frequency in one or more combustors 42 is driven away from that of the other combustors 42, coherence and, therefore, modal coupling of combustion dynamics may be reduced.

FIG. 8 provides a side cross-sectional view of the combustion section 16 of the gas turbine 10 shown in FIG. 1, according to an aspect of the present disclosure that incorporates various coherence-mitigation approaches previously described and illustrated with respect to FIGS. 3 and 6 into multiple combustors 42. In the particular embodiment shown in FIG. 8, multiple combustors 42 are arranged about an axis 126 of the gas turbine 10. The axis 126 may coincide, for example, with the shaft 54 that connects the compressor section 14 to the turbine section 18, although the present invention is not limited to the particular orientation of the axis 126 or the particular arrangement of the combustors 42 about the axis 126. Although two representative and oppositely disposed combustors 42 are shown in FIG. 8, the present invention is not limited to any specific number of combustors 42 or any specific spatial relationship of the combustors 42 to one another, unless recited in the claims.

As shown in FIG. 8, each combustor 42 includes multiple fuel nozzles 70 with the combustion chamber 68 downstream from the fuel nozzles 70 as previously described with respect to FIGS. 2, 3, and 6. In the particular example shown in FIG. 8, the axial distances between the combustion chamber 68 and the fuel ports 100 and/or swirler vanes 98 in one or more combustors 42 are configured to produce a different convective time in at least one fuel nozzle 70 and/or in at least one combustor 42, thereby reducing the modal coupling of the combustion dynamics. Specifically, as illustrated, each axial distance 102 between the fuel ports 100 and the combustion chamber 68 and between the swirler vanes 98 and the combustion chamber 68 is different for each fuel nozzle 70 in each combustor 42. As a result, different combustion dynamics frequencies are produced in each fuel nozzle 70 in one or more combustors 42.

One of ordinary skill in the art will readily appreciate from the teachings herein that multiple combinations of variations in the axial distances 102 between the combustion chamber 68 and the swirler vanes 98, between the combustion chamber 68 and the fuel ports 100 on the swirler vanes 98, and/or between the combustion chamber 68 and the fuel ports 100 on the center body 92 may be employed to produce a combustion dynamics frequency in one or more combustors 42 that is substantially different from the combustion dynamics frequency in the other combustors 42. For example, in particular embodiments, one or more axial distances 102 between the fuel ports 100 and the combustion chamber 68 and/or the swirler vanes 98 and the combustion chamber 68 may be substantially the same or substantially different for one or more of the fuel nozzles 70 in a particular combustor 42 compared to at least one other combustor 42, as long as the axial distances 102 are not all the same for all fuel nozzles 70 in all combustors 42. Accordingly, the present disclosure is not limited to any particular combination of axial distances 102, unless specifically recited in the claims.

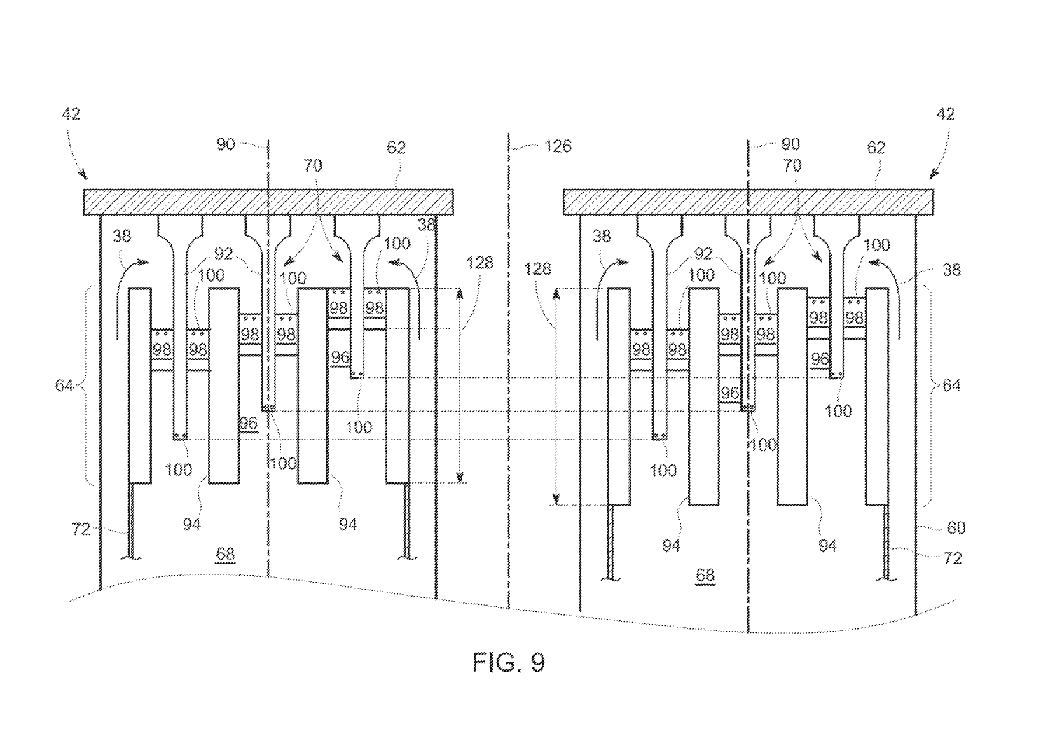

FIG. 9 provides a side cross-sectional view of the combustion section 16 of the gas turbine 10, according to yet another aspect of the present disclosure. As shown in FIG. 9, each combustor 42 includes multiple fuel nozzles 70 with the combustion chamber 68 downstream from the fuel nozzles 70 as previously described. The axial positions of the fuel ports 100 and/or the swirler vanes 98 with respect to the end cover 62 may be substantially the same or substantially different in one or more of the combustors 42, as compared to the remaining combustors 42.

The variation shown in FIG. 9 provides an alternate approach to reducing the modal coupling of the combustion dynamics produced by the combustors 42. In this particular variation, the axial length 128 of the cap assembly 64 in one combustor 42 is substantially different from the axial length 128 of the cap assembly 64 in at least one other combustor 42. Although two representative and oppositely disposed combustors 42 are shown in FIG. 9, the present invention is not limited to any specific number of combustors 42 or any specific spatial relationship of the combustors 42 to one another, unless recited in the claims.

With the axial positions of the fuel ports 100 and the swirler vanes 98 with respect to the end cover 62 repeated in two or more combustors 42, the difference in the axial lengths 128 between the two or more combustors 42 produces a corresponding difference in the axial distances 102 between the fuel ports 100 and the combustion chamber 68 and the swirler vanes 98 and the combustion chamber 68 for two or more combustors 42. Said differently, for the combustor 42 having a longer axial cap length, the axial distances 102 between the combustion chamber 68 and the swirler vanes 98 and fuel ports 100 is longer. The differences in axial distances 102 between two or more combustors 42 produces a corresponding difference in the convective times and, therefore, in the combustion dynamics frequencies between the two or more combustors 42. As the combustion dynamics frequency in one or more combustors 42 is driven away from that of the other combustors 42, coherence and, therefore, modal coupling of combustion dynamics may be reduced.

It should be noted that the axial positions of the fuel ports 100 and swirler vanes 98 with respect to the end cover 62 do not necessarily need to be repeated for each combustor 42, provided that the combination of the axial positions of the fuel ports 100 and swirler vanes 98 with respect to the end cover 62 and the cap length 128 results in a difference in convective time and, therefore, frequency between at least two combustors 42. For example, one or more axial distances 102 between the fuel ports 100 and the combustion chamber 68 and/or the swirler vanes 98 and the combustion chamber 68 may be substantially different for one or more of the fuel nozzles 70 in a particular combustor 42 compared to at least one other combustor 42.

One of ordinary skill in the art will readily appreciate from the teachings herein that multiple combinations of variations in the axial distances 102 between the fuel ports 100 and the combustion chamber 68 and/or the swirler vanes 98 and the combustion chamber 68 are possible to produce a combustion dynamics frequency in one combustor 42 that is different from the combustion dynamics frequency in at least one other combustor 42. It should also be appreciated that while reference is made to single combustors 42 that are oppositely disposed from one another, the combustors may be grouped into sub-sets having substantially the same axial distances 102 and cap lengths 128 (e.g., “Can A” combustors and “Can B” combustors) and may be positioned at any location in the combustor array. The present invention is not limited to any particular combination of axial distances 102 or axial cap lengths 128, unless specifically recited in the claims.

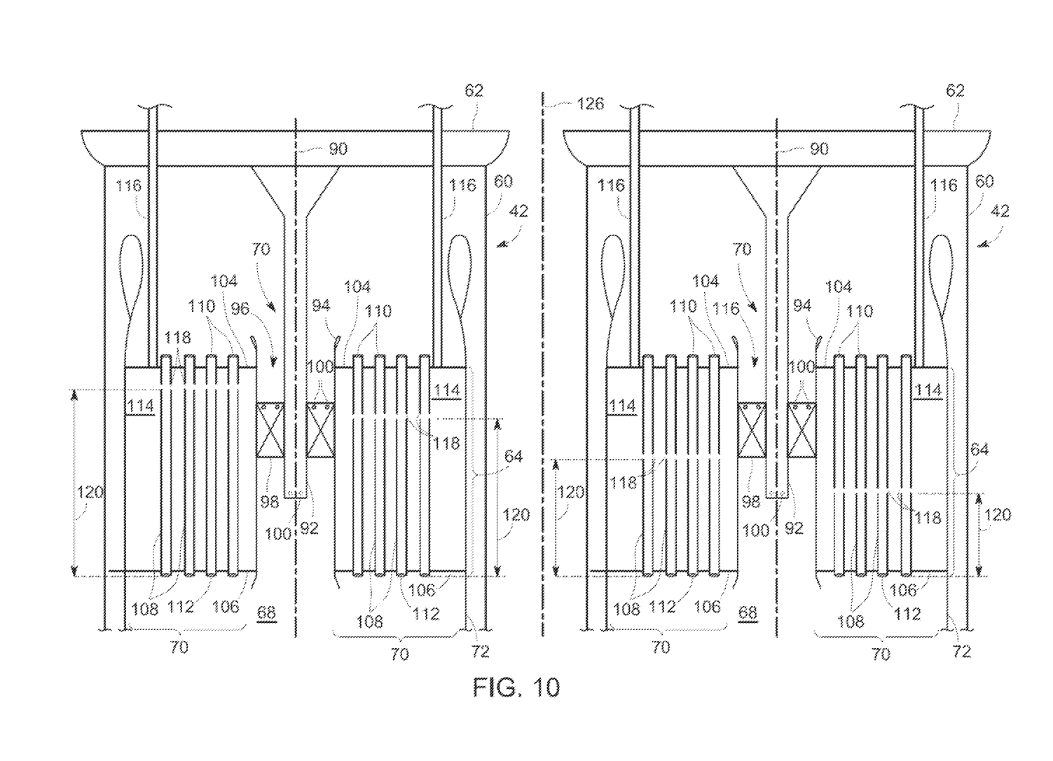

FIG. 10 provides a side cross-sectional view of the combustion section 16 of the gas turbine 10 shown in FIG. 1, according to an alternate embodiment of the present disclosure that incorporates various coherence-mitigation approaches previously described and illustrated with respect to FIGS. 5 and 7 into multiple combustors 42. In the exemplary variation shown in FIG. 10, multiple combustors 42 (having the fuel nozzles shown in FIGS. 5 and 7) have been arranged about the axis 126 of the gas turbine 10. Although two representative and oppositely disposed combustors 42 are shown in FIG. 10, the present invention is not limited to any specific number of combustors 42 or any specific spatial relationship of the combustors 42 to one another, unless recited in the claims.

As shown in FIG. 10, each combustor 42 includes multiple tubes 108 arranged in pie-shaped fuel nozzles 70 that circumferentially surround the center fuel nozzle 70, and the combustion chamber 68 is downstream from the tubes 108 and fuel nozzles 70 as previously described. The gas turbine 10 includes substantially different axial distances 120 between the fuel ports 118 and the combustion chamber 68 for one or more fuel nozzles 70 in one or more combustors 42 as compared to the other combustors 42. In the particular embodiment shown in FIG. 10 by way of example, the axial distance 120 between the fuel ports 118 and the combustion chamber 68 for each fuel nozzle 70 is different between the two combustors 42. As a result, different combustion dynamics frequencies are produced in the two combustors 42.

One of ordinary skill in the art will readily appreciate from the teachings herein that multiple combinations of variations in the axial distances 120 between the fuel ports 118 and the combustion chamber 68 are possible to produce a combustion dynamics frequency in one combustor 42 that is substantially different from the combustion dynamics frequency in at least one other combustor 42. For example, one or more axial distances 120 between the fuel ports 118 and the combustion chamber 68 may be the same for one or more of the fuel nozzles 70 in a particular combustor 42 as compared to the other combustor 42, as long as the axial distances 120 are not all substantially the same for all fuel nozzles 70 in all combustors 42. It is also contemplated that the axial distances 102 between the fuel ports 100 of the center nozzle 70 and the combustion chamber 38 and/or the axial distances between the swirler vanes 98 and the combustion chamber 38 in one combustor 42 may be substantially different from those in one or more other combustors 42, either in addition to or instead of varying the axial distances 120. Thus, the present invention is not limited to any particular combination of axial distances 102, 120, unless specifically recited in the claims.

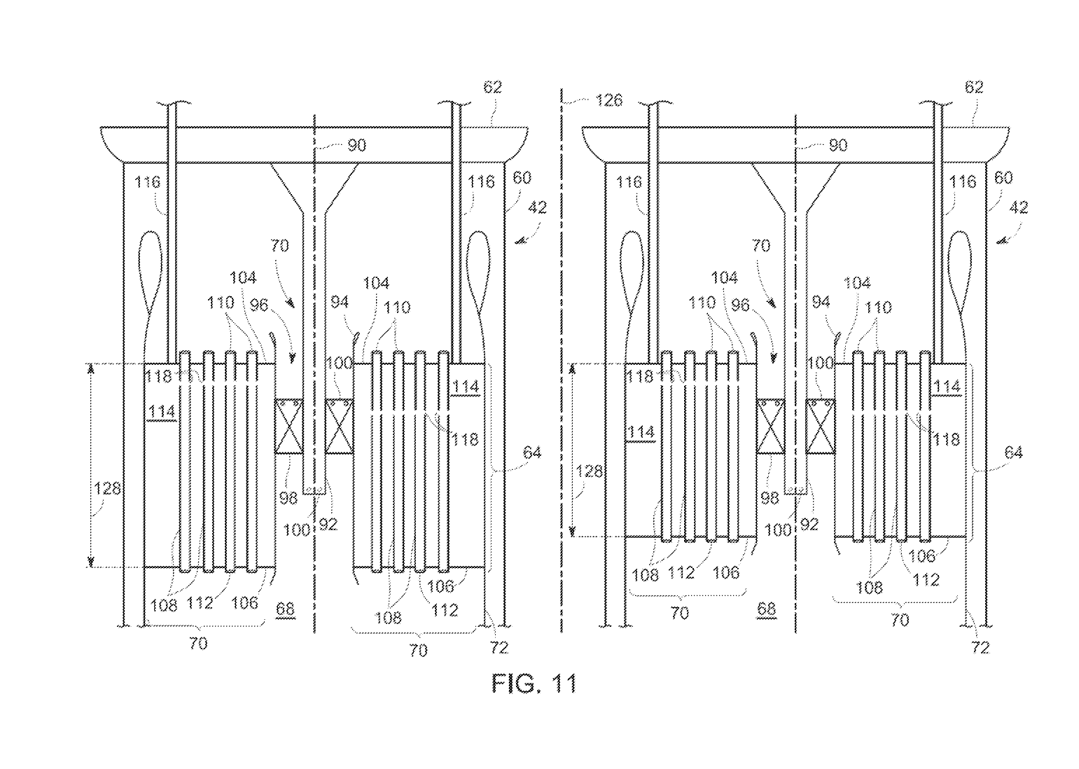

FIG. 11 provides a side cross-sectional view of the combustion section 16 of the gas turbine 10, according to another aspect contemplated by the present disclosure. As shown in FIG. 11, each combustor 42 includes multiple tubes 108 arranged in pie-shaped fuel nozzles 70 that circumferentially surround the center fuel nozzle 70, and the combustion chamber 68 is downstream from the tubes 108 and fuel nozzles 70. The axial positions of the fuel ports 118 may be substantially the same or substantially different in each combustor 42 with respect to the end cover 62.

The embodiment shown in FIG. 11 includes a configuration in which the axial length 128 of the cap assembly 64 in one combustor 42 is substantially different from the axial length 128 of the cap assembly 64 in at least one other combustor 42. With the axial positions of the fuel ports 118 with respect to the end cover 62 repeated in one or more combustors 42, the difference in the axial lengths 128 between two or more combustors 42 produces a corresponding difference in the axial distances 120 between the fuel ports 118 and the combustion chamber 68 between the two or more combustors 42. The difference in axial distances 120 between the two or more combustors 42 produces a corresponding difference in the convective times and, therefore, in the combustion dynamics frequencies between the two or more combustors 42. It should be noted that the axial positions of the fuel ports 118 with respect to the end cover 62 do not necessarily need to be repeated for each combustor 42, provided that the combination of the axial positions of the fuel ports 118 with respect to the end cover 62 and the cap length 128 results in a difference in convective time and, therefore, a frequency difference between at least two combustors 42.

One of ordinary skill in the art will readily appreciate from the teachings herein that multiple combinations of variations in the axial distances 120 between the fuel ports 118 and the combustion chamber 68 are possible to produce a combustion dynamics frequency in one combustor 42 that is substantially different from the combustion dynamics frequency in the other combustor 42. For example, in particular embodiments, one or more axial distances 120 between the fuel ports 118 and the combustion chamber 68 may be the same for one or more of the tubes 108 and/or fuel nozzles 70 in a particular combustor 42 compared to the other combustor 42, as long as the axial distances 120 are not all the same for all fuel nozzles 70 in all combustors 42.

Further, either in addition to or instead of varying the axial distances 120 and/or the axial cap lengths 128, the axial distances 102 between the fuel ports 100 of the center nozzle 70 and the combustion chamber 38 and/or the axial distances between the swirler vanes 98 and the combustion chamber 38 in one combustor 42 may be substantially different from those in one or more other combustors 42. As before, the present invention is not limited to any particular combination of axial distances 102, axial distances 120, and/or axial cap lengths 128, unless specifically recited in the claims.

Alternately, or in addition, to the approaches provided herein, the modal coupling of the combustion system can also be altered by changing the air side effective area of one or more of the fuel nozzles 70. The amount of fluid flow through the fuel nozzles 70 is proportional to an effective area 122 of the annular passage 96 of the fuel nozzles 70 defined by the center body 92 and the shroud 94, shown in FIG. 6. Alternatively, the effective area of the fuel nozzle 70 may also be defined by the cumulative effective area 124 of the tubes 108, shown in FIG. 7. The effective area 122, 124 of each fuel nozzle 70 is the net area through which the compressed working fluid 38 (e.g., air) can pass through the fuel nozzle 70 and may be calculated as the total minimum cross-sectional area in the fuel nozzle 70 multiplied by the coefficient of flow. The coefficient of flow is the ratio of the actual and theoretical maximum flows through the fuel nozzle 70.

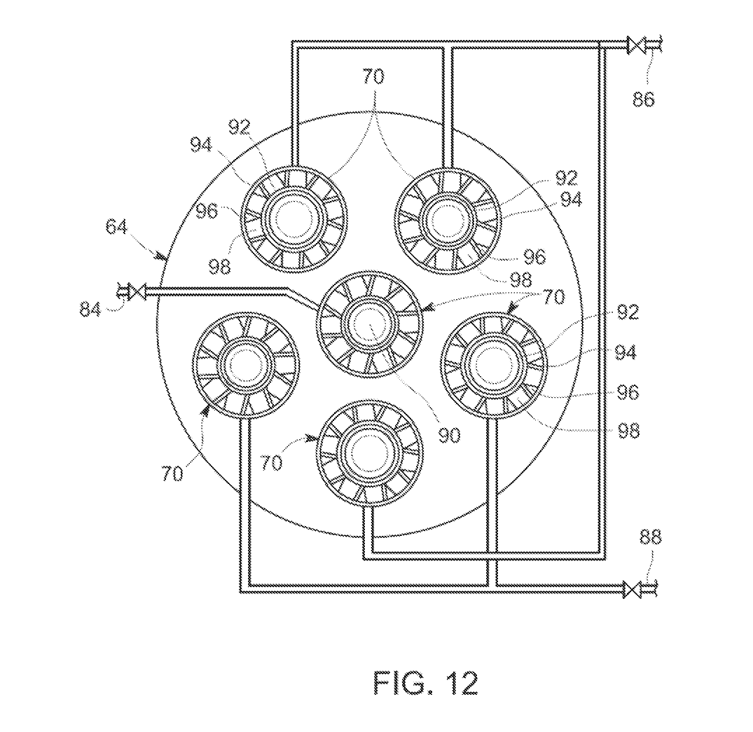

By varying the amount of fluid flow through the individual fuel nozzles 70, the fuel/air ratio of the fuel will be changed, which can vary the combustion dynamics frequency for that fuel nozzle. FIGS. 12-14 provide upstream plan views for various arrangements of the fuel nozzles 70 in the cap assembly 64, according to additional embodiments of the present disclosure that incorporate the structure previously described and illustrated with respect to FIGS. 3 and 5.

In these particular embodiments, the combustion dynamics and/or modal coupling of the combustors 42 may be reduced by adjusting the fluid flow of the compressed working fluid 38 and/or the mixture of compressed working fluid 38 and fuel through individual fuel nozzles 70 within the same combustor 42. The fuel nozzles 70 in the same combustor 42 may be provided with different air side effective areas. For example, one or more fuel nozzles 70 in the same combustor 42 may have a center body 92 with a substantially different size and/or shape along at least a portion of the length of the center body 92. Alternately, or in addition, one or more fuel nozzles 70 in the same combustor may be provided with a burner tube 94 having a substantially different size and/or shape along at least a portion of the length of the burner tube 94.

These modifications in the dimensions of the center body 92 and/or the burner tube 94 result in a different-sized or shaped annular passage 96 along at least a portion of the length of the annular passage 96, thereby varying the amount of fluid flow for one or more fuel nozzles 70 compared to the other fuel nozzles 70. As the amount of fluid flow through the fuel nozzles 70 varies, the fuel/air ratio of the fuel nozzle 70 and, therefore, the combustion dynamics frequency may also vary. Further tuning of the fuel/air ratio of the fuel nozzles 70 may be achieved by biasing fuel flow to or away from the same fuel nozzle 70, either within a fuel circuit or from fuel circuit to fuel circuit. Biasing of the fuel flow may not be necessary in all cases, but, in some cases, may be desirable to minimize the impact to the combustor's production of noxious emissions.

FIG. 12 provides an upstream plan view of the cap assembly 64 shown in FIG. 3, according to another aspect of the present disclosure. As shown in FIG. 12, at least one of the outer fuel nozzles 70 may have a center body 92 with a substantially different diameter along at least a portion of its length, as compared to the diameters of the center bodies of the other nozzles 70, resulting in a cross-sectional flow area of the annular passage 96 that is substantially different from the other nozzles 70. Additionally, the center fuel nozzle 70 may have a center body 92 with a diameter substantially different from the outer nozzles (not shown), producing a third cross-sectional flow area of the annular passage 96. In this exemplary arrangement, two of the fuel nozzles 70 associated with the tertiary fuel circuit 86 and one of the fuel nozzles 70 associated with the secondary fuel circuit 88 are provided with the center bodies 92 having a larger diameter than the remaining fuel nozzles 70 associated with the primary, secondary, and tertiary fuel circuits 84, 88, 86.

In FIG. 12, the fuel nozzles 70 with the larger center bodies 92 have a smaller cross-sectional flow area of the annular passage 96, compared to the remaining fuel nozzles 70. The smaller cross-sectional flow area produces a corresponding decrease in the amount of the mixture of compressed working fluid 38 and fuel flowing through the annular passage 96 of the fuel nozzles 70. The decreased flow results in a corresponding increase in the fuel/air ratio associated with the fuel nozzle 70 compared to the other fuel nozzles in the same fuel circuit with larger cross-sectional flow area of the annular passage 96.

As a result, the combustion dynamics frequency generated by the fuel nozzles 70 with the larger center bodies 92 will be substantially different from that generated by the fuel nozzles 70 with the smaller center bodies 92, reducing or precluding constructive interference between the fuel nozzles 70 and reducing the amplitude of the combustion dynamics. Reducing the amplitude sufficiently may reduce the coherence and, therefore, the modal coupling of the combustion dynamics in the combustors 42. The frequency of the resulting combustion dynamics in any one combustor 42 is the result of the constructive and destructive interference between the fuel nozzles 70 and depends on the specific combination of fuel/air ratios of the fuel nozzles 70.

As noted above, a reduction of the annular passage 96 may result in a reduction of working fluid 38 flowing through the annular passage of the fuel nozzle 70. Further tuning of the fuel/air ratio of the fuel nozzles 70 may be achieved by biasing fuel flow to or away from the same fuel nozzle 70, either within a fuel circuit or from fuel circuit to fuel circuit. Biasing of the fuel flow may not be necessary in all cases, but, in some cases, may be desirable to minimize the impact to the combustor's production of noxious emissions.

One of ordinary skill in the art will readily appreciate from the teachings herein that multiple combinations of variations in the diameter of the center bodies 92 are possible to achieve a desired combustion dynamics frequency for each fuel nozzle 70 and/or desired combustion dynamics for the particular combustor 42. For example, the diameter of the center bodies 92 may be substantially the same or substantially different for some or all of the fuel nozzles 70 in a particular combustor 42, and the present invention is not limited to any particular combination of center body 92 diameters, unless specifically recited in the claims.

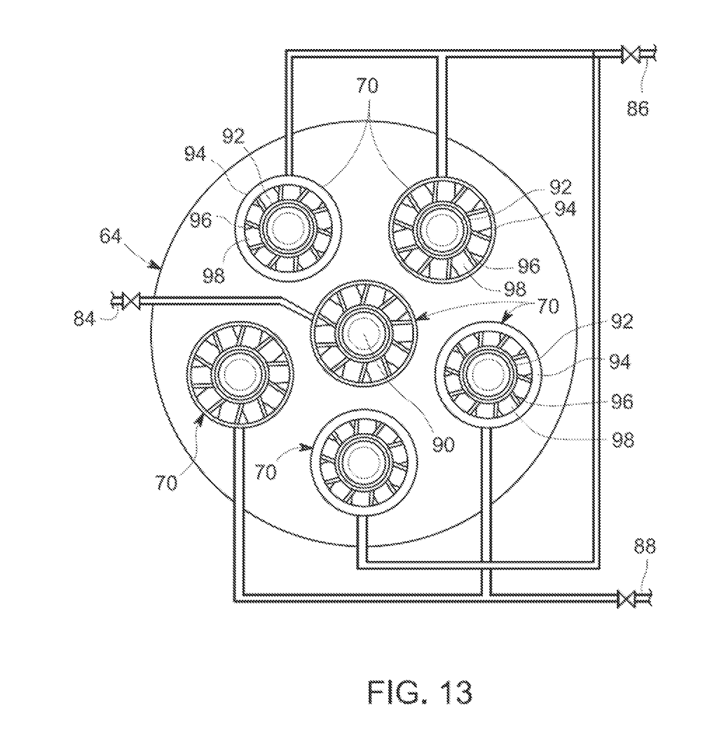

Alternately, or in addition to, FIG. 13 provides an upstream plan view of the cap assembly 64 shown in FIG. 3. In FIG. 13, at least one of the outer fuel nozzles 70 may have a burner tube 94 having an inner diameter that is substantially different from the remaining outer fuel nozzles 70, resulting in a cross-sectional flow area of the annular passage 96 that is substantially different from the other nozzles 70. Additionally, the center fuel nozzle 70 may have a burner tube 94 having an inner diameter substantially different from the outer fuel nozzles 70 (not shown), such that a third cross-sectional flow area of the annular passage 96 is produced. In this exemplary arrangement, two of the fuel nozzles 70 associated with the tertiary fuel circuit 86 and one of the fuel nozzles 70 associated with the secondary fuel circuit 88 are each provided with a burner tube 94 having a smaller inner diameter than the remaining fuel nozzles 70 associated with the primary, secondary, and tertiary fuel circuits 84, 88, 86.

To create a smaller inner diameter for the burner tube 94, the burner tube 94 may be made thicker, or the burner tube 94 may be fabricated to have a smaller diameter and the same wall thickness as the burner tubes 94 of the other fuel nozzles 70, along at least a portion of their length. In FIG. 13, for the fuel nozzles 70 having burner tubes 94 with a smaller inner diameter, the annular passage 96 for these fuel nozzles 70 possesses a smaller cross-sectional flow area 122, as compared to the remaining fuel nozzles 70. The smaller cross-sectional flow area 122 produces a corresponding decrease in the amount of flow through the fuel nozzle 70. The decreased flow results in a corresponding increase in the fuel/air ratio associated with the fuel nozzle 70.

As a result, the combustion dynamics frequency generated for the fuel nozzles 70 with the different inner diameter burner tubes 94 will be substantially different, reducing or precluding constructive interference between the fuel nozzles 70. Reducing the amplitude sufficiently may reduce the coherence and, therefore, the modal coupling of the combustion dynamics in the combustors 42. The frequency of the resulting combustion dynamics in any one combustor 42 is the result of the constructive and destructive interference between the fuel nozzles 70 and depends on the specific combination of the fuel/air ratios of the fuel nozzles 70.

As noted with respect to FIG. 12, a reduction of the annular passage 96 may result in a reduction of working fluid 38 flowing through the annular passage of the fuel nozzle 70. Further tuning of the fuel/air ratio of the fuel nozzles 70 may be achieved by biasing fuel flow to or away from the same fuel nozzle 70, either within a fuel circuit or from fuel circuit to fuel circuit. Biasing of the fuel flow may not be necessary in all cases, but, in some cases, may be desirable to minimize the impact to the combustor's production of noxious emissions.

One of ordinary skill in the art will readily appreciate from the teachings herein that multiple combinations of variations in the inner diameter of the burner tubes 94 are possible to achieve a desired combustion dynamics frequency for each fuel nozzle 70 and/or desired combustion dynamics for the particular combustor 42. For example, the inner diameter of the burner tubes 94 may be substantially the same or substantially different for some or all of the fuel nozzles 70 in a particular combustor 42. Thus, the present invention is not limited to any particular combination of the inner diameters of the burner tubes 94, unless specifically recited in the claims.

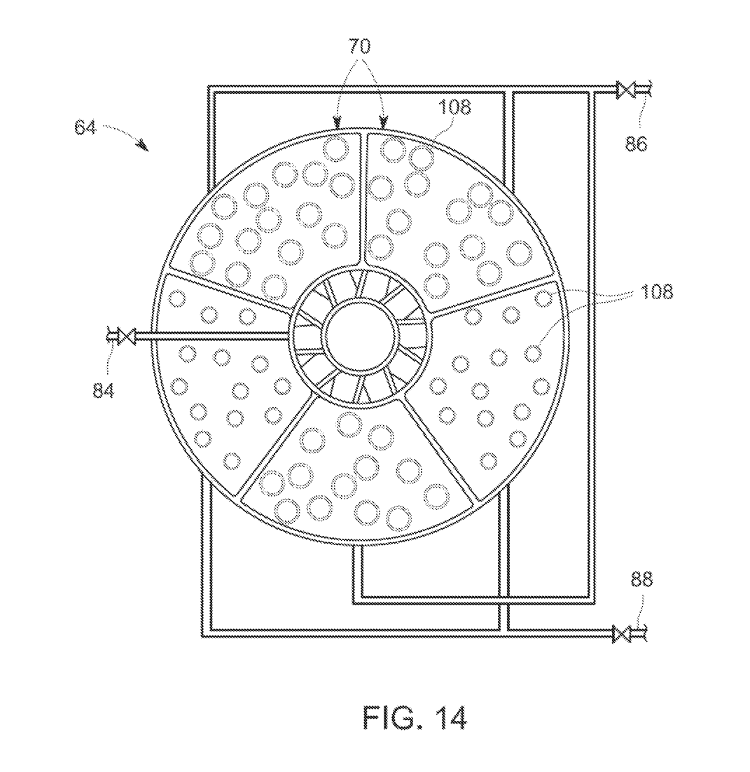

FIG. 14 provides an upstream plan view of an exemplary arrangement of the fuel nozzles 70 in the cap assembly 64 (as shown in FIG. 5), according to yet another aspect of the present disclosure. In this particular embodiment, the coherence and, therefore, modal coupling of the combustion dynamics may be reduced by adjusting the amount of the compressed working fluid 38 and/or fuel through at least one fuel nozzle 70 within the same combustor 42. In this aspect the fuel nozzles 70 are tube bundle-type nozzles, some of which have tubes 108 of substantially different diameters. In this exemplary arrangement, the tubes 108 in the fuel nozzles 70 associated with the secondary fuel circuit 88 have a substantially smaller diameter than the tubes 108 in the fuel nozzles 70 associated with the tertiary fuel circuit 86.

In FIG. 14, the fuel nozzles 70 with the smaller diameter tubes 108 have a corresponding decrease in the flow of the mixture of compressed working fluid 38 and fuel flowing through the tubes 108 in the fuel nozzles 70. The decreased fluid flow results in a corresponding increase in the fuel/air ratio associated with the fuel nozzle 70. As a result, the combustion dynamics frequency generated for the fuel nozzles(s) 70 with the smaller diameter tubes 108 is substantially different from those with the larger diameter tubes 108, reducing or precluding constructive interference between the fuel nozzles 70. Reducing the amplitude sufficiently may reduce the coherence and, therefore, the modal coupling of the combustion dynamics in the combustor 42. The frequency of the resulting combustion dynamics in any one combustor 42 is the result of the constructive and destructive interference between the fuel nozzles 70, and depends on the specific combination of the fuel/air ratios of the fuel nozzles 70.

According to the inventive aspect provided in FIG. 14, a reduction of the inner diameter (size) of the tubes 108 may result in a reduction of working fluid 38 flowing through the tubes 108. Further tuning of the fuel/air ratio of the fuel nozzles 70 may be achieved by biasing fuel flow to or away from the same fuel nozzle 70, either within a fuel circuit or from fuel circuit to fuel circuit. Biasing of the fuel flow may not be necessary in all cases, but, in some cases, may be desirable to minimize the impact to the combustor's production of noxious emissions.

One of ordinary skill in the art will readily appreciate from the teachings herein that multiple combinations of variations in the diameter of the tubes 108 in each fuel nozzle 70 are possible to achieve a desired combustion dynamics frequency for each fuel nozzle 70 and/or desired combustion dynamics for the particular combustor 42. For example, the diameter of the tubes 108 may be substantially the same or substantially different for some or all of the fuel nozzles 70 in a particular combustor 42, and the present invention is not limited to any particular combination of diameters of tubes 108, unless specifically recited in the claims.

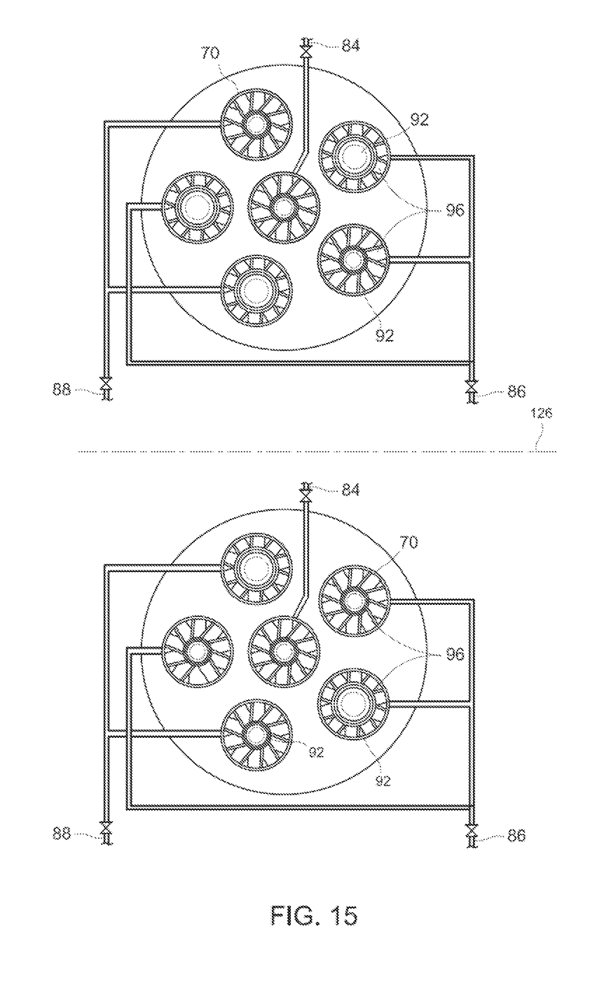

The combustion dynamics associated with multiple combustors 42 incorporated into the gas turbine 10 may either constructively or destructively interfere with one another to increase or decrease the amplitude and/or coherence of the combustion dynamics associated with the gas turbine 10. FIGS. 15-17 illustrate various embodiments in which one or more of the structures shown in FIGS. 12-14 may be incorporated into one or more combustors 42 to adjust and/or tune the fuel/air ratios in the combustors 42 to decouple interaction of the combustion dynamics between multiple combustors 42 in the same gas turbine 10.

FIG. 15 provides an upstream plan view of a combustion section of the gas turbine 10 of FIG. 1, according to an alternate embodiment of the present disclosure that incorporates into multiple combustors 42 the modifications to the center body diameters, which were previously described and illustrated with respect to FIG. 12. In the particular embodiment shown in FIG. 15, multiple combustors 42, as shown in FIGS. 3 and 12, are arranged about the axis 126 of the gas turbine 10. Although two representative and oppositely disposed combustors 42 are shown in FIG. 15, the present invention is not limited to any specific number of combustors 42 or any specific spatial relationship of the combustors 42 to one another, unless recited in the claims.

As shown in FIG. 15, each combustor 42 includes multiple fuel nozzles 70 as previously described. In this particular embodiment, the coherence and, therefore, modal coupling of the combustion dynamics of the combustors 42 may be reduced by adjusting the amount of fluid flow of the mixture of the compressed working fluid 38 and fuel through one or more fuel nozzles 70 in one or more combustors 42. One or more fuel nozzles 70 in one or more combustors 42 may be provided with a center body 92 having a substantially different diameter or shape along at least a portion of the length of the center body 92, resulting in a different cross-sectional effective area of the annular passage 96 along at least a portion of its length.

In the exemplary arrangement shown in FIG. 15, two of the fuel nozzles 70 associated with the tertiary fuel circuit 86 and one of the fuel nozzles 70 associated with the secondary fuel circuit 88 in a first combustor have a center body of larger diameter than the remaining fuel nozzles 70. In the other combustor 42, one of the fuel nozzles 70 associated with the secondary fuel circuit 88 and one of the fuel nozzles 70 associated with the tertiary fuel circuit 86 have a center body 92 of larger diameter than the remaining fuel nozzles. While the fuel nozzles 70 having a center body 92 of larger diameter are shown as being oppositely disposed within the combustor, such location is not a requirement.

The difference in cross-sectional effective area 122 varies the amount of fluid flow through the annular passage 96 of the modified fuel nozzle 70, which varies the fuel/air ratios between the various fuel nozzles 70 in one or more combustors 42. Therefore, the resulting differences in the cross-sectional areas between the annular passages 96 of the fuel nozzles 70 produce corresponding differences in the combustion dynamic frequencies between the combustors 42 to decouple the combustion dynamics frequencies of the combustors 42.

As noted with respect to FIGS. 12 and 13, a reduction of the annular passage 96 may result in a reduction of working fluid 38 flowing through the annular passage of the fuel nozzle 70. Further tuning of the fuel/air ratio of the fuel nozzles 70 may be achieved by biasing fuel flow to or away from the same fuel nozzle 70, either within a fuel circuit or from fuel circuit to fuel circuit. Biasing of the fuel flow may not be necessary in all cases, but, in some cases, may be desirable to minimize the impact to the combustor's production of noxious emissions.

One of ordinary skill in the art will readily appreciate from the teachings herein that multiple combinations of variations in the center body 92 diameters are possible to produce a combustion dynamics frequency in one or more combustors 42 that is different from the combustion dynamics frequency in the other combustors 42. For example, one or more center body 92 diameters may be substantially the same or substantially different for one or more of the fuel nozzles 70 in a particular combustor 42 compared to at least one other combustor 42, as long as the center body 92 diameters are not all the same for all fuel nozzles 70 in all combustors 42. Thus, the present invention is not limited to any particular combination of center body 92 diameters, unless specifically recited in the claims.

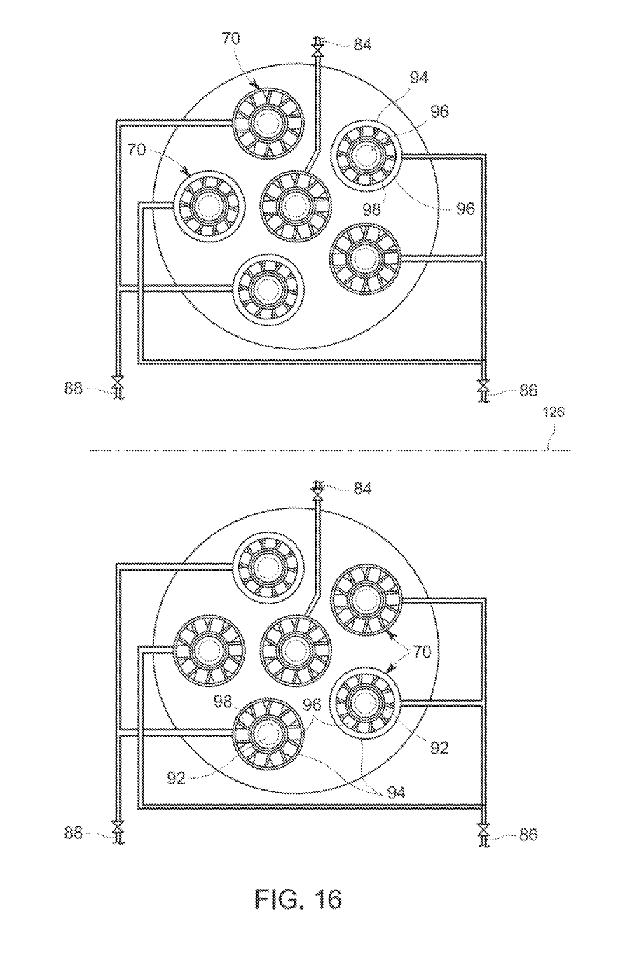

FIG. 16 provides an upstream plan view of a combustion section of the gas turbine 10 of FIG. 1, according to an alternate aspect of the present disclosure that incorporates into multiple combustors 42 the modifications to the inner diameters of the burner tubes 94, which were previously described and illustrated with respect to FIG. 13. In the particular embodiment shown in FIG. 16, multiple combustors 42, as shown in FIGS. 3 and 13, have been arranged about the axis 126 of the gas turbine 10. Although two representative and oppositely disposed combustors 42 are shown in FIG. 16, the present invention is not limited to any specific number of combustors 42 or any specific spatial relationship of the combustors 42 to one another, unless recited in the claims.

As shown in FIG. 16, each combustor 42 includes multiple fuel nozzles 70 as previously described. In this particular embodiment, the coherence and, therefore, modal coupling of the combustion dynamics of the combustors 42 may be reduced by adjusting the amount of the mixture of the compressed working fluid 38 and fuel through one or more fuel nozzles 70 in one or more combustors 42. One or more fuel nozzles 70 in one or more combustors 42 have a burner tube 94 with a substantially larger or substantially smaller inner diameter along at least a portion of the length of the burner tube 94.

In the exemplary arrangement shown in FIG. 16, two of the fuel nozzles 70 associated with the tertiary fuel circuit 86 and one of the fuel nozzles 70 associated with the secondary fuel circuit 88 in a first combustor have a burner tube 94 of smaller inner diameter than the remaining fuel nozzles 70 in the first combustor. In the second combustor 42, one of the fuel nozzles 70 associated with the secondary fuel circuit 88 and one of the fuel nozzles 70 associated with the tertiary fuel circuit 86 have a burner tube 94 of smaller inner diameter than the remaining fuel nozzles in the second combustor. While the fuel nozzles 70 having a burner tube 94 of smaller inner diameter are shown as being oppositely disposed within the combustor 42, such location is not a requirement.

The difference in the inner diameters of the burner tubes 94 results in a different cross-sectional effective area 122 of the annular passage 96, which varies the amount of fluid flow through the annular passage 96. Changing the amount of the fluid flow through the annular passage 96 varies the fuel/air ratios between the various fuel nozzles 70 in one or more combustors 42, which varies the combustion dynamic frequencies between the combustors 42.

As noted previously, a reduction of the annular passage 96 may result in a reduction of working fluid 38 flowing through the annular passage of the fuel nozzle 70. Further tuning of the fuel/air ratio of the fuel nozzles 70 may be achieved by biasing fuel flow away to or from the same fuel nozzle 70, either within a fuel circuit or from fuel circuit to fuel circuit. Biasing of the fuel flow may not be necessary in all cases, but, in some cases, may be desirable to minimize the impact to the combustor's production of noxious emissions.

One of ordinary skill in the art will readily appreciate from the teachings herein that multiple combinations of variations in the inner diameter of the burner tube 94 are possible to produce a combustion dynamics frequency in one or more combustors 42 that is different from the combustion dynamics frequency in the other combustors 42. For example, in particular embodiments, one or more burner tube 94 inner diameters may be substantially the same or substantially different for one or more of the fuel nozzles 70 in a particular combustor 42 compared to at least one other combustor 42, as long as the burner tube 94 inner diameters are not all the same for all fuel nozzles 70 in all combustors 42. As before, the present invention is not limited to any particular combination of burner tube 94 inner diameters, unless specifically recited in the claims.

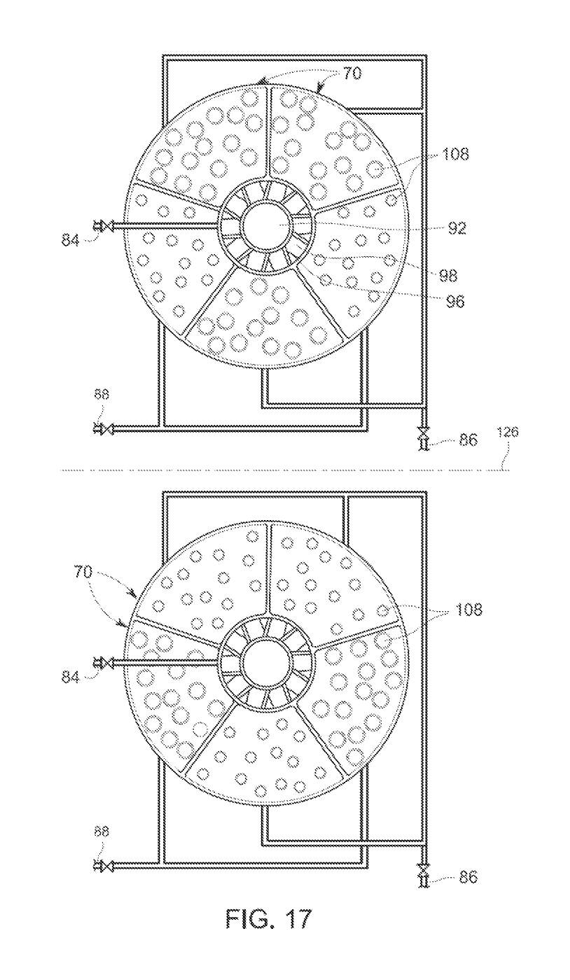

FIG. 17 provides an upstream plan view of a combustion section of the gas turbine 10 of FIG. 1, according to a further aspect of the present disclosure that incorporates into multiple combustors 42 the modifications to the diameters of the tubes 108 in the fuel nozzles 70, the modifications having been previously described and illustrated with respect to FIG. 14. In the particular embodiment shown in FIG. 17, multiple combustors 42 (as shown in FIGS. 4 and 14) have been arranged about the axis 126 of the gas turbine 10. Although two representative and oppositely disposed combustors 42 are shown in FIG. 17, the present invention is not limited to any specific number of combustors 42 or any specific spatial relationship of the combustors 42 to one another, unless recited in the claims.

As shown in FIG. 17, each combustor 42 includes multiple fuel nozzles 70 as previously described. In this particular embodiment, the coherence and, therefore, modal coupling of the combustion dynamics of the combustors 42 may be reduced by adjusting the amount of the mixture of the compressed working fluid 38 and fuel through one or more fuel nozzles 70 in one or more combustors 42. One or more tube bundle-type fuel nozzles 70 in one or more combustors 42 may be provided with tubes 108 having a substantially larger or substantially smaller diameter along at least a portion of the length of the tubes 108.

In the exemplary arrangement shown in FIG. 17, the fuel nozzles 70 associated with the tertiary fuel circuit 86 in a first combustor have tubes 108 of a larger diameter than the remaining fuel nozzles 70 in the first combustor. In the second combustor 42, the fuel nozzles 70 associated with the secondary fuel circuit 88 have tubes 108 of a larger diameter than the remaining fuel nozzles in the second combustor. While the fuel nozzles 70 having tubes 108 with larger diameters are shown as being oppositely disposed within the combustor 42, such location is not a requirement. Changing the diameter of the tubes 108 alters the amount of the fluid flow through the tubes 108, which varies the fuel/air ratios between the various fuel nozzles 70 in one or more combustors 42. Accordingly, the combustion dynamic frequencies between the combustors 42 are also modified.

As noted above, a reduction of the annular passage 96 may result in a reduction of working fluid 38 flowing through the annular passage of the fuel nozzle 70. Further tuning of the fuel/air ratio of the fuel nozzles 70 may be achieved by biasing fuel flow to or away from the same fuel nozzle 70, either within a fuel circuit or from fuel circuit to fuel circuit. Biasing of the fuel flow may not be necessary in all cases, but, in some cases, may be desirable to minimize the impact to the combustor's production of noxious emissions.

One of ordinary skill in the art will readily appreciate from the teachings herein that multiple combinations of variations in the diameters of the tubes 108 in the fuel nozzles 70 are possible to produce a combustion dynamics frequency in one or more combustors 42 that is different from the combustion dynamics frequency in the other combustors 42. For example, in particular embodiments, the diameter of the tubes 108 may be the same or different for one or more of the fuel nozzles 70 in a particular combustor 42 compared to at least one other combustor 42, as long as the diameter of the tubes are not all the same for all fuel nozzles 70 in all combustors 42. Thus, the present invention is not limited to any particular combination of diameters of the tubes 108, unless specifically recited in the claims.

FIGS. 2 and 18-20 illustrate another approach to varying the convective time between combustors 42 by varying the flow rate of the compressed working fluid 38 through the head end 66 and fuel nozzles 70 for one or more combustors 42. As shown in FIG. 2, the combustor 42 may further include a secondary combustion zone or region, having one or more fuel injectors 128 that are circumferentially arranged around the combustion chamber 68 to provide fluid communication radially through the liner 72 and/or the transition duct 74 into the combustion chamber 68. The present invention is not limited to any particular location or type of fuel injectors 128, unless specifically recited in the claims.

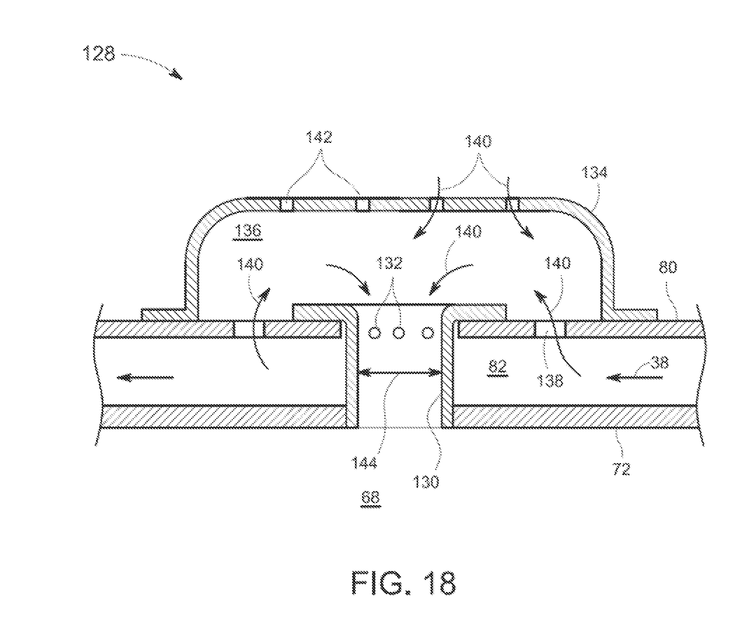

FIG. 18 provides an enlarged side cross-sectional view of an exemplary fuel injector 128, which may be used in the present gas turbine systems. As shown in FIG. 18, each fuel injector 128 may include a tube 130 or other passage that provides fluid communication through the flow sleeve 80 and the liner 72 into the combustion chamber 68, and a plurality of fuel ports 132 provide fluid communication for fuel to flow into the combustion chamber 68. In the exemplary embodiment shown in FIG. 18, the tube 130 is substantially perpendicular to the flow sleeve 80 and liner 72 to inject the fuel-air mixture transverse to the flow of combustion products within the combustion chamber 68. However, in other embodiments, the tube 130 may be angled axially and/or circumferentially with respect to the flow sleeve 80 and/or liner 72.

In the particular embodiment shown in FIG. 18, a cap 134 may be associated with one or more of the fuel injectors 128 to define a separate volume 136 around the particular fuel injector 128 outside of the flow sleeve 80. Each cap 134 may be bolted or otherwise fixedly connected to the flow sleeve 80, for example around a circumference of the particular fuel injector 128, to define the separate volume 136 around the particular fuel injector 128. One or more fluid passages 138 through the flow sleeve 80 may provide fluid communication from the annular passage 82, through the flow sleeve 80, and into each separate volume 136.

In some instances, the fluid passages 138 through the flow sleeve 80 may be upstream from the particular fuel injector 128. In other instances, the fluid passages 138 through the flow sleeve 80 may circumferentially surround each particular fuel injector 128, as in the particular configuration shown in FIG. 18. In this manner, the compressed working fluid 38 may provide cooling to the outside of the liner 72, and a portion 140 of the compressed working fluid may be diverted through the fluid passages 138 and into the separate volume 136 surrounding the particular fuel injector 128. The diverted portion 140 of the compressed working fluid may then mix with fuel from the fuel ports 132 (fuel supply not shown) before flowing into the combustion chamber 68 to provide a premixed injection of fuel and air for secondary combustion.

The cap 134 and the separate volume 136 created by the cap 134 may isolate the particular fuel injector 128 from the pressure and flow variations typically present in the compressor discharge plenum 40. In addition, in some instances, one or more flow passages 142 through the caps 134 may provide fluid communication from the compressor discharge plenum 40 directly into each separate volume 136. In this manner, the flow passages 142 may allow additional compressed working fluid 140 to flow directly into the volume 136 and bypass the annular passage 82 to increase the amount of compressed working fluid 38 diverted through the particular fuel injector 128.

It should be understood that the fuel injector 128 shown in FIG. 18 is merely one exemplary injector, and other injector designs or configurations may be used instead, including those that protrude through the liner 72 and into the combustion chamber. The present disclosure is not limited to the exemplary fuel injector design, as the principles disclosed herein are equally applicable to any style of injectors in a secondary combustion zone.

Regardless of the injector design, the amount of compressed working fluid 140 diverted through the fuel injectors 128 is directly proportional to an effective area 144 of the fuel injectors 128 for each combustor 42. The effective area 144 of each fuel injector 128 is the net area through which the diverted compressed working fluid 140 can pass into or out of the fuel injector 128 and may be calculated as the total minimum cross-sectional area in the fuel injector 128 multiplied by the coefficient of flow. The coefficient of flow is the ratio of the actual and theoretical maximum flows through the fuel injector 128.

For example, the effective area 144 of the fuel injector 128 of FIG. 18 is calculated using the minimum cross-sectional area inside the tube 130 through which the diverted compressed working fluid 140 flows out of the fuel injector 128 and into the combustion chamber 68. In other particular embodiments, the effective area 144 may be calculated from the sum of the cross-sectional areas of the fluid passages 138 and/or flow passages, if present, through which the diverted working fluid 140 flows.

The amount of compressed working fluid 38 that flows through the head end 66 and fuel nozzles 70 determines the convective time and, therefore, the combustion instability frequency associated with the combustors 42. The amount of compressed working fluid 140 diverted through the fuel injectors 128 reduces the amount of compressed working fluid 38 available to flow through the head end 66 and fuel nozzles 70, provided the total effective area of each combustor 42 is approximately the same. The effective area of each combustor can be maintained by compensating for a change in effective area of the fuel injectors 128 in a combustor 42 by a corresponding change in the effective area of the flow holes 78 through the impingement sleeve 76 and/or flow sleeve 80 in the same combustor 42.

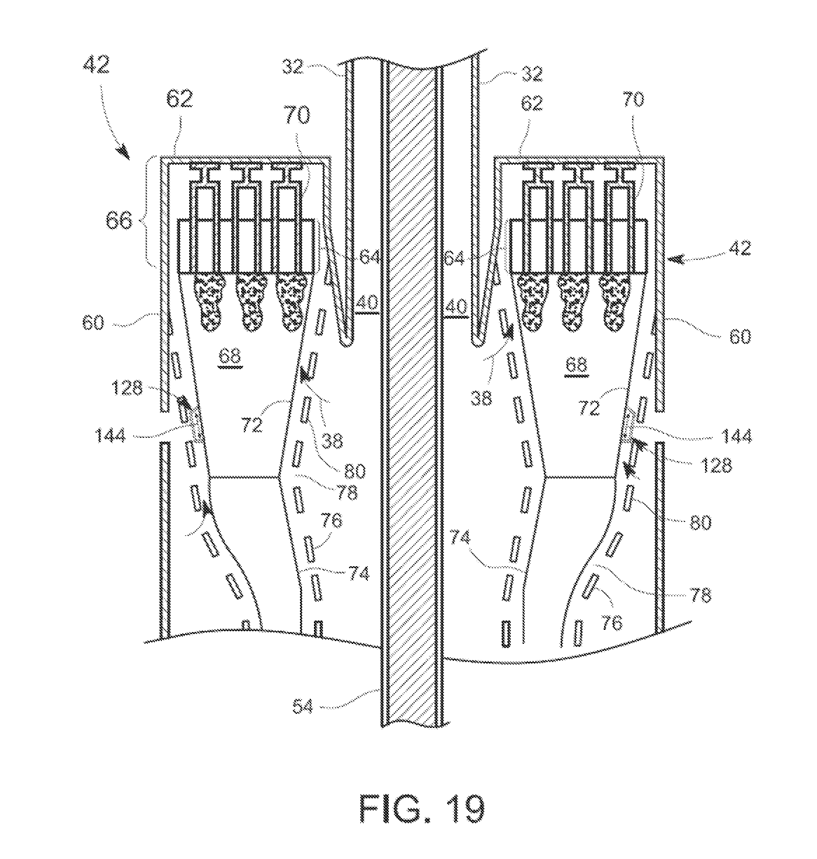

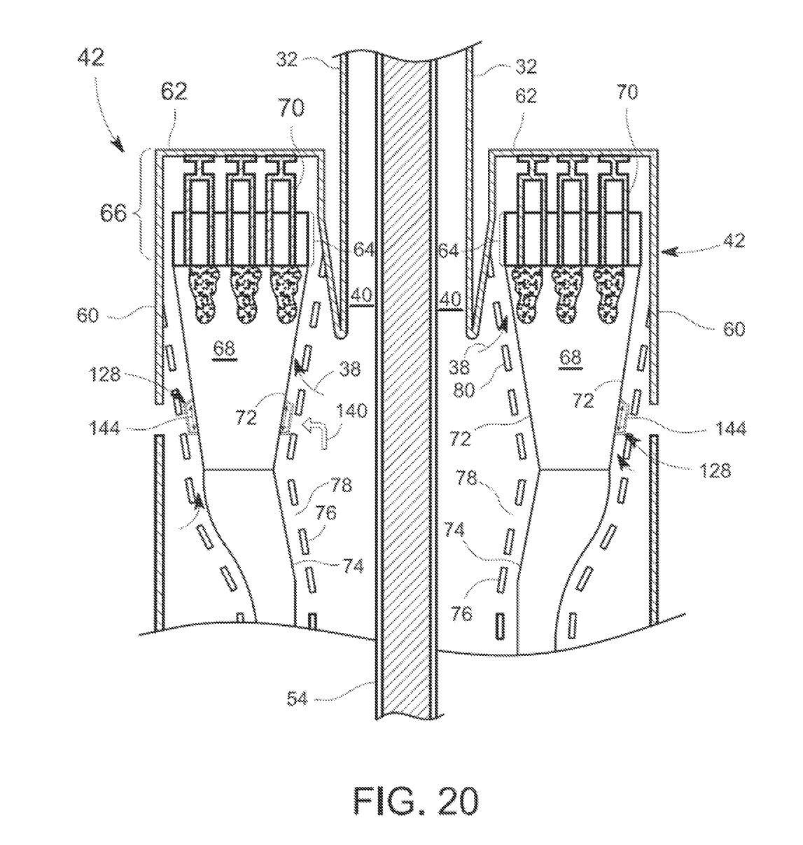

In particular embodiments, the amount of compressed working fluid 140 diverted through the fuel injectors 128 and flow holes 78 may be different and/or adjusted for each combustor 42 to change the amount of compressed working fluid 38 that flows through the head end 66 and fuel nozzles 70 for each combustor 42. The different amounts of compressed working fluid 38 flowing through the head end 66 and fuel nozzles 70 of each combustor 42 produces different convective times and frequencies between combustors 42 to reduce the modal coupling of combustion dynamics. FIGS. 19 and 20 illustrate various embodiments for varying the amount of compressed working fluid 140 diverted through the fuel injectors 128.

FIG. 19 provides a simplified side cross-sectional view of the combustion section 16 of the gas turbine 10 shown in FIG. 1, according to yet another embodiment of the present disclosure. Although two representative and oppositely disposed combustors 42 are shown in FIG. 19, the present invention is not limited to any specific number of combustors 42 or any specific spatial relationship of the combustors 42 to one another, unless recited in the claims.

As shown in FIG. 19, each combustor 42 includes multiple fuel nozzles 70 radially arranged in the head end 66 to provide fluid communication through the cap assembly 64 and into the combustion chamber 68. Each combustor 42 further includes a secondary combustion zone having a set of one or more fuel injectors 128 that provide fluid communication radially through the liners 72 and into the combustion chambers 68.

According to an aspect of the present disclosure, the set of fuel injectors 128 in a first combustor 42 (shown on the left side of FIG. 19) are larger and/or define a larger effective area 144 for fluid flow than the set of fuel injectors 128 in a second combustor (shown on the right side of FIG. 19). This difference in effective areas 144 may be accomplished by any combination of varying the diameter of the tubes 130 and/or the passages 138, 142 of the fuel injectors 128, previously described with respect to FIG. 18. In addition, to maintain the comparable fluid flow rates through each combustor 42, the flow openings 78 through the impingement sleeve 76 and/or flow sleeve 80 in the first combustor may be smaller and/or fewer, thereby defining a smaller collective effective area for fluid flow, than the flow openings 78 through the impingement sleeve 76 and/or flow sleeve 80 in the second combustor. It should be noted that the relative sizes of the fuel injectors 128 and the flow openings 78 are exaggerated for clarity and do not necessarily represent actual dimensions.

As the compressed working fluid 38 flows from the compressor discharge plenum 40 to each combustor 42, a portion of the compressed working fluid 140 flows through the fuel injectors 128 in the secondary combustion zone, and the remainder of the compressed working fluid 38 flows through the fuel nozzles 70 in the head end 66 of each combustor 42, as previously described with respect to FIG. 2. The larger effective area 144 of the fuel injectors 128 combined with the smaller effective area of the flow holes 78 in the first combustor allows a larger amount and/or flow rate of compressed working fluid 140 to be diverted through the fuel injectors 128 in the first combustor, as compared to the fuel injectors 128 in the second combustor. As a result, the volume and/or flow rate of compressed working fluid 38 available to flow through the fuel nozzles 70 is greater for the second combustor 42 (on the right) as compared to the first combustor 42 (on the left).

As previously discussed with respect to FIGS. 18 and 19, the larger flow rate through the head end 66 and fuel nozzles 70 of the primary combustion zone produces a shorter convective time and higher frequency for the second combustor 42, as compared to the first combustor 42. The difference in combustion instability frequency between the two combustors 42 reduces coherence between the combustors 42, thereby reducing the modal coupling of combustion dynamics between combustors 42.

FIG. 20 provides a simplified side cross-sectional view of the combustion section 16 of the gas turbine 10 shown in FIG. 1, according to another aspect of the present disclosure. In this exemplary configuration, each fuel injector 128 in the secondary combustion zones may have the same effective area 144. However, the first combustor 42 (shown on the left) has more fuel injectors 128 than the second combustor 42 (shown on the right), allowing a larger amount and/or flow rate of compressed working fluid 140 to be diverted through the fuel injectors 128 in the first combustor 42, as compared to the fuel injectors 128 in the second combustor. As before, to maintain the comparable fluid flow rates through each combustor 42, the flow openings 78 through the impingement sleeve 76 and/or flow sleeve 80 in the first combustor 42 may be smaller and/or define a smaller effective area for fluid flow than the flow openings 78 through the impingement sleeve 76 and/or flow sleeve 80 in the second combustor 42.

As a result of these different effective areas, the volume and/or flow rate of compressed working fluid 38 available to flow through the fuel nozzles 70 at the head end 66 of the second combustor is greater than that available for the fuel nozzles 70 of the first combustor 42. As previously discussed with respect to FIGS. 18 and 19, the larger flow rate through the head end 66 and fuel nozzles 70 produces a shorter convective time and higher frequency for the second combustor 42, as compared to the first combustor 42. The difference in frequency between the two combustors 42 reduces coherence between the combustors 42, thereby reducing the modal coupling of combustion dynamics between combustors 42.

Although the first combustor 42 is shown with two fuel injectors 128 and the second combustor is shown with one fuel injector 128, it should be recognized that any number of fuel injectors 128 may be used in either combustor, provided the number of fuel injectors 128 in the first combustor is different from the number of fuel injectors 128 in the second combustor 42. Further, it should be appreciated that the fuel injectors 128 in the combustors 42 may be arranged with different circumferential spacing (that is, the fuel injectors 128 do not have to be oppositely disposed, or otherwise uniformly spaced, around the circumference of the combustor 42). Moreover, it is possible to vary the effective area of the injectors 128 in the first combustor 42 from the effective area of the injectors 128 in the second combustor 42 by modifying both the size and number of injectors 128.

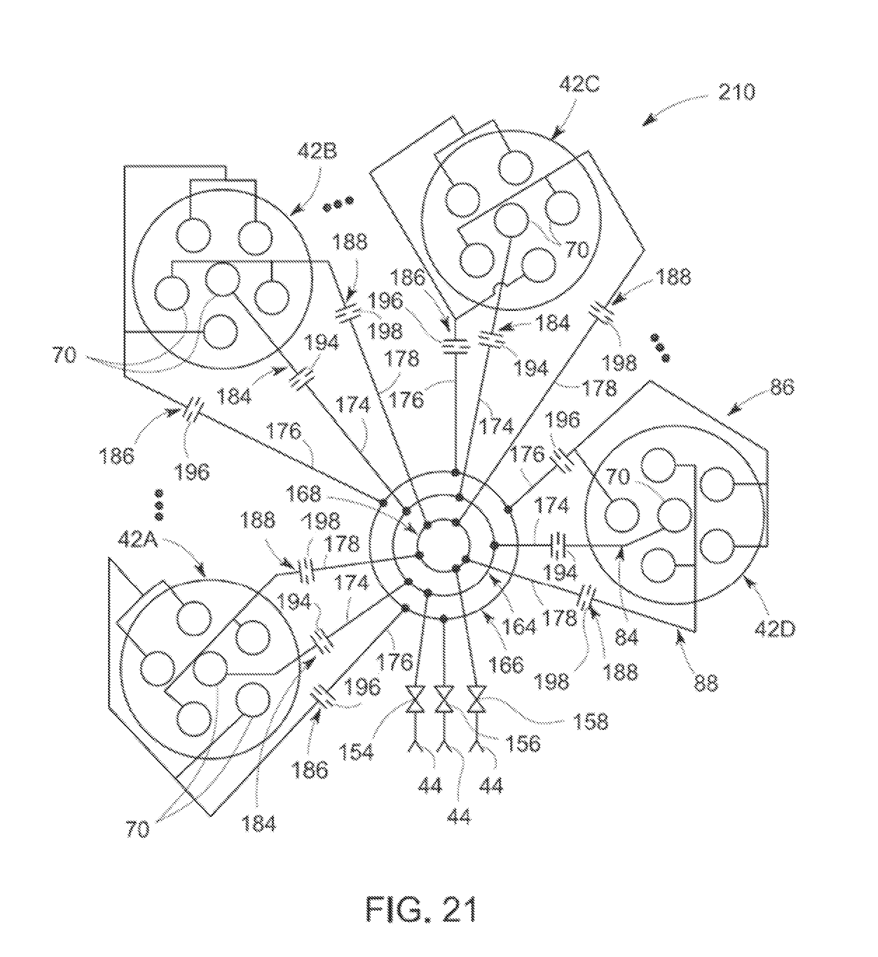

FIG. 21 provides a schematic diagram of a system 210 for reducing modal coupling of combustion dynamics according to aspects of the present disclosure, which may be incorporated into the gas turbine 10 previously described. Although four combustors 42 are shown (individually labeled 42A, 42B, 42C, and 42D), the present gas turbine system is not limited to any specific number of combustors 42, unless specifically recited in the claims. Moreover, there is no significance to the labels assigned to each combustor, and no inference about their position or importance should be made based upon any label assigned thereto.

As illustrated, each combustor 42 includes multiple fuel nozzles 70, and fuel supply lines 174, 178, and/or 176 provide fluid communication between the fuel supply 44 and the fuel nozzles 70. While a single fuel supply 44 is shown, it should be understood that two or more different supplies of the same or different fuels may be employed, if desired.

An overlap between the combustion instability frequency and the downstream component resonant frequency may result in unwanted vibration of the downstream components, particularly when an in-phase and coherent relationship exists between two or more combustors 42. Altering the fuel split through the fuel supply lines 174, 176, 178 between at least two combustors 42 varies the frequencies and/or amplitudes between at least two combustors 42. As a result of this combustor-to-combustor split bias, the embodiments of the present disclosure may reduce coherence and, therefore, modal coupling of the combustion dynamics between combustors 42.

To facilitate multiple fueling schemes over a range of operations, the fuel nozzles 70 are arranged into groups or sets. By way of example, the primary fuel nozzle group includes the center fuel nozzle 70, the secondary fuel nozzle group includes two non-adjacent fuel nozzles 70 radially outward of the center fuel nozzle, and the tertiary fuel nozzle group includes three fuel nozzles 70 radially outward of the center fuel nozzle 70. Other groupings of fuel nozzles 70 may instead be used, including groupings that include the center fuel nozzle 70 and one or more of the surrounding fuel nozzles 70. For each fuel nozzle group, one of the first, second, and third fuel supply lines 174, 178, 176 extends from one of the respective fuel manifolds 164, 168, 166 (as part of overall fuel circuits 84, 88, 86) and provides fluid communication to the respective groups of nozzles 70.

The fuel circuits 84, 86, 88 (shown initially in FIGS. 3-5) are shown in greater detail in FIG. 21. Primary, secondary, and tertiary fuel circuits (84, 86, 88) include a gas control valve (154, 158, 156); a fuel manifold (164, 168, 166); a plurality of fuel supply lines (174, 178, 176) directing fuel from a respective fuel manifold (164, 168, 166) to a respective fuel nozzle group. For instance, the secondary fuel nozzle group in the combustor 42A is in fluid communication with a fuel supply line 178 that extends from the secondary fuel manifold 168 that receives fuel from the secondary gas control valve 158. Another fuel supply line 178 extends between the secondary fuel manifold 168 to the secondary fuel nozzle group in the combustor 42B. Similarly, the primary nozzle groups and the tertiary fuel nozzle groups in each combustor 42 are fueled by respective primary and tertiary fuel manifolds 164,166.

During base load operations, all of the fuel lines 174, 176, 178 may be used to supply fuel to the fuel nozzles 70 in the combustors 42 (with respective fuel lines 174, 178, 176 supplying respective primary, secondary, and tertiary groupings of the fuel nozzles 70). Fuel flow may be reduced or completely eliminated from one or more groups of the fuel nozzles 70 during reduced or turndown operations, as dictated by the primary, secondary, and tertiary gas control valves 154, 158, 156 connected to the corresponding primary, secondary, and tertiary fuel manifolds 164, 168, 166. Furthermore, according to one aspect of the present disclosure, the relative fuel flow in each fuel circuit 84, 86, 88 may be varied at a given operating condition, while maintaining constant total fuel flow in each combustor 42, to alter the combustion dynamics amplitudes and/or frequencies and/or to alter the emissions generated by the combustion system 16.

Optionally, an orifice plate (184, 188, 186) is disposed along the fuel supply line between the fuel manifold (164, 168, 166) and the fuel nozzles 70 (as shown in FIG. 21). The fuel flow through each fuel manifold (164, 168, 166), and ultimately to each group of fuel nozzles 70, may be controlled by the respective gas control valves and these strategically designed orifice plates (184, 188, 186). Orifice plates (184, 186, 188) in the respective fuel circuits (84, 88, 86) upstream from the fuel nozzles 70 produce a fuel split between the fuel nozzles 70 in each combustor 42 and/or between different combustors 42, as will be discussed further herein.

Specifically, an orifice plate 184, 188, 186 may be used to limit flow through the respective fuel supply lines 174, 178, 176 to one or more groups of fuel nozzles 70 in one or more combustors 42. As used herein, an “orifice plate” is defined as a plate having one or more holes, or orifices, therethrough, which limit fluid flow through the fuel supply line in which the orifice plate is installed.

In one exemplary embodiment, the orifice plates (184, 188, 186) produce a different fuel split for one or more groups of fuel nozzles 70 in one or more combustors 42. A change in the fuel nozzle pressure ratio and/or equivalence ratio resulting from differences in the fuel flow rate to a given fuel nozzle 70 or group of fuel nozzles 70 may directly affect the combustion instability frequency and/or amplitude in each combustor 42. As the frequency of the combustion dynamics in one or more combustors 42 is driven away from that of the other combustors 42, coherence and, therefore, modal coupling of the combustion dynamics are reduced. As a result, various embodiments of the present disclosure may reduce the ability of the combustor tone to cause a vibratory response in downstream components.

The holes in each orifice plate 184, 186, 188 collectively define an effective area 194, 196, 198 through the plate that determines the volume and mass flow of fluid (e.g., fuel) through the plate for a given differential pressure across the plate. The effective area 194, 196, 198 of each orifice plate 184, 186, 188 is the combined area through which the fuel can pass and may be calculated as the total cross-sectional area of the holes in the orifice plate 184, 186, 188 multiplied by the coefficient of flow. The coefficient of flow is the ratio of the actual and theoretical maximum flows through the orifice plate 184, 186, 188.

The effective area 194, 196, 198 for each orifice plate 184, 186, 188 may be different for each fuel supply line 174, 176, 178 based on the number of fuel nozzles 70 being fed by each fuel supply line 174, 176, 178, as well as the desired difference, or bias, in the fuel splits from a first combustor (e.g., 42A) to a second combustor (e.g., 42B). Changing the fuel split between the fuel nozzles 70 directly affects the frequency and/or amplitude of the combustion dynamics, and changing the frequency in one or more combustors 42 may reduce coherence and, therefore, modal coupling of combustion dynamics.

In the exemplary arrangement shown in FIG. 21, the effective area 194 of at least one of the primary orifice plates 184 is different from the effective area 198 of at least one of the secondary orifice plates 188, and the effective area 198 is different from the effective area 196 of at least one of the tertiary orifice plates 186. In one arrangement, at least one of the effective areas 182, 184, 186 is different between two or more combustors 42 to produce a difference in combustion dynamics frequencies between two or more combustors 42. It should be understood that, while reference is made to individual combustors 42 in the describing various arrangements, the principles described herein may be equally applied to combustor groups having two or more combustors 42.

By way of further example, the primary orifice plate 184 in the fuel supply line 174 supplying a first combustor 42A may define a first effective area 194, while a primary orifice plate 184 in the fuel supply line 174 supplying a second combustor 42B may define a different effective area 194′, as compared to the effective area 194 of the primary orifice plate 184 associated with the first combustor 42A. Optionally, the primary orifice plate 184 in the fuel line 174 supplying a third combustor 42C may define yet another effective area 194″, which is different from the effective areas 194 and/or 194′. Additional primary orifice plates 184 having one or more effective areas 194 that are different from other effective areas 194, 194′, 194″ may also be used for other combustors 42 or combustor groups, if so desired. For the sake of clarity, the prime (′) and double prime (″) symbols have been omitted from FIG. 21.

Similarly, the secondary orifice plate 188 in the fuel supply line 178 supplying a first combustor 42A may define a second effective area 198, while a secondary orifice plate 188 in the fuel supply line 178 supplying the second combustor 42B may define a different effective area 198′, as compared to the effective area 198 of the secondary orifice plate 198 associated with the first combustor 42A. Optionally, the secondary orifice plate 188 in the fuel line 178 supplying a third combustor 42C may define yet another effective area 198″, which is different from the effective areas 198 and/or 198′. Additional secondary orifice plates 188 having one or more effective areas 198 that are different from other effective areas 198, 198′, 198″ may also be used for other combustors 42 or combustor groups, if so desired.

The pattern of different effective areas may be similarly applied to the tertiary orifice plates 186, supplying fuel from the fuel supply lines 176 to yet another group of fuel nozzles 70 in each combustor 42. As described above, different combustors (e.g., 42A, 42B, 42C) are supplied by respective fuel supply lines 176, one or more of which may be provided with its own tertiary orifice plate 186. The tertiary orifice plate 186 supplying fuel to the first combustor 42A may define an effective area 196; the tertiary orifice plate 186 associated with the second combustor 42B may define an effective area 196′ different from the effective area 196; and, optionally, the tertiary orifice plate 186 associated with the third combustor 42C may define yet another effective area 196″, which is different from the effective areas 196 and/or 196′. Additional tertiary orifice plates 186 having one or more effective areas 196 that are different from other effective areas 196, 196′, 196″ may also be used for other combustors 42 or combustor groups, if so desired.

As a result, one or more orifice plates 184, 186 188 varies the fuel splits between two or more combustors 42, which may alter the amplitude and/or frequency of the combustion dynamics between two or more combustors 42 to reduce coherence and modal coupling of combustion dynamics. In many cases, but not all, it may be desirable to maintain a similar total fuel flow to each combustor 42 to maintain a similar temperature of the combustion gases 46 generated by each combustor 42. In such cases, a similar total fuel flow to each combustor may be maintained by ensuring the sum of the effective areas 194, 196, 198 is the same, or approximately the same, for each combustor 42.

It should be understood that, although FIG. 21 shows an orifice plate (184, 186, 188) in connection with every fuel supply line (174, 176, 178) into each combustor 42, such a configuration is not required. In some instances, orifice plates 184 may be installed, in some of the combustors, on the fuel supply lines (174) supplying primary groups of fuel nozzles 70 while orifice plates 188 may be installed, in other of the combustors, on the fuel supply lines (178) supplying secondary groups of fuel nozzles 70. The primary orifice plates 184 in the fuel supply lines 174 associated with the primary fuel nozzle groups may be identical to one another in terms of effective area 194, but may define an effective area that is different from the effective area 198 defined by the secondary orifice plates 188 in the fuel supply lines 178 associated with the secondary fuel nozzle groups. In this example, the fuel flow to the tertiary group of fuel nozzles 70 in each combustor 42 would be unimpeded by a respective tertiary orifice plate 186.

Alternately, not all of the combustors 42 require an orifice plate (184, 186, 188). For instance, on some combustors 42 (e.g., 42A, 42B), the orifice plates 188 may be used on the fuel supply lines 178 supplying the secondary group of fuel nozzles 70. On others of the combustors 42 (e.g., 42C, 42D), the orifices plates 186 may be used on the fuel supply lines 176 supplying the tertiary group of fuel nozzles 70. The effective area 198 of the secondary orifice plates 188 may be different from the effective area 196 of the tertiary orifice plates 186. The combustors 42 having altered fuel flow by the inclusion of orifice plates 186, 188 may or may not be grouped in any particular pattern (e.g., adjacent or alternating).

In some limited circumstances, it may even be possible to achieve the desired frequency variation by installing orifice plates (e.g., 186) having different effective areas 196, 196′, etc. on only one of the fuel circuits (e.g., 86), assuming the frequency variation can be achieved with only a small variation in the exhaust temperature from combustor 42 to combustor 42.

One of ordinary skill in the art will readily appreciate from the teachings herein that the system 210 described and illustrated with respect to FIG. 21 may provide a method for reducing the coherence and, therefore, modal coupling of the combustion system 16. The method may include flowing fuel through orifice plates 184, 186, and/or 188 having the same or different effective areas 194, 196, 198 for one or more sets of fuel nozzles 70 in the combustor 42, and the effective areas 194, 196, and/or 198 may be different between at least two combustors 42, as described with respect to the particular configuration shown in FIG. 21.

As discussed with reference to FIGS. 1-21, the present disclosure provides a number of mechanisms to reduce modal coupling of combustion dynamics by varying the convective time between combustors or altering the fuel nozzle pressure ratios and/or equivalence ratios from combustor to combustor. In many cases, there will be additional advantages obtained by combining two or more of these mechanisms within the same combustion system. By way of example and not limitation, a system for reducing modal coupling of combustion dynamics may incorporate into multiple combustors 42 the modifications to swirler vane and fuel port spacing and burner tube diameter that were previously described and illustrated with respect to FIGS. 3, 8, 13 and 16.

Many other combinations of the coherence-disrupting mechanisms described herein may be employed in a gas turbine system, including, without limitation:
(a) fuel supply lines with orifice plates connected to a primary fuel nozzle group in each combustor, in which the orifice plates have one or more variations in effective area combustor-to-combustor, and the fuel nozzle group defining fuel ports having variations in fuel port axial distance combustor-to-combustor
(b) the arrangement of (a), in which the fuel ports may be located on a fuel nozzle vane, a fuel nozzle center body, or a tube bundle-type fuel nozzle; and/or in which the burner tube and/or center body of the fuel nozzle may have different diameters combustor-to-combustor; and/or in which the tube bundle-type fuel nozzle may include tubes of different diameters combustor-to-combustor;
(c) the arrangement of (a) or (b), in which a set of orifice plates are connected to the secondary fuel nozzle group in each combustor, the orifice plates having one or more variations in effective area combustor-to-combustor and, optionally, in which the fuel flow rate from one or more of the fuel circuits is different from combustor-to-combustor;
(d) the arrangement of (a), (b), or (c), in which fuel injectors are positioned downstream of the fuel nozzles and define an effective cross-sectional area through the combustor liner; and in which the liner of each combustor defines a set of flow openings having a collective effective area; the effective cross-sectional area of the fuel injectors in a second combustor being larger than the effective cross-sectional area of the fuel injector(s) in a second combustor, and the collective effective area of the flow openings in the first combustor being larger than the collective effective area of the flow openings in the second combustor;
(e) fuel supply lines with orifice plates having variations in effective area combustor-to-combustor coupled with (i) downstream fuel injectors having variations in effective cross-sectional area combustor-to-combustor and (ii) outer sleeve flow openings having variations in collective effective area combustor-to-combustor, where the variations in effective cross-sectional area are larger in the combustor for which the variations in collective cross-sectional area are smaller;
(f) burner tubes having variations in inner diameter and/or fuel nozzles having center bodies with variations in center body diameter, such variations being along at least a portion of the axial length of the respective burner tubes and/or center bodies and being present combustor-to-combustor
(g) fuel supply lines with orifice plates having variations in effective area combustor-to-combustor coupled with fuel nozzles including bundles of tubes, each tube having a fuel port located at a fuel port axial distance from the combustion chamber, in which the fuel port axial distance is substantially different in one combustor as compared to another combustor;
(h) the arrangement of any of the above, in which the flow rate of the compressed working fluid delivered to the fuel nozzles in the first combustor is substantially different from the flow rate of the compressed working fluid delivered to the fuel nozzles in the second combustor and
(i) the arrangement of any of the above, in which the combustor cap assembly defines an axial cap length, the axial cap length in the first combustor being substantially different from the axial cap length in the second combustor.

The systems depicted in FIGS. 8-11, 15-17, and 19-21 may include three or more combustors 42 incorporated into the gas turbine 10 or other turbomachine. By using one or more of the mechanisms described herein for producing a combustion dynamics frequency in one combustor 42A that is different from the combustion dynamics frequency in the other combustor 42B, each combustor 42 (or group of combustors 42) may be adjusted or tuned to achieve a desired combustion dynamics frequency. A group of combustors may include one or more combustors 42. The combustors 42 in a group need not be arranged in any particular spatial orientation (for instance, adjacent to one another or in an alternating pattern with combustors of one or more groups).

By way of example and not limitation, a first group of the combustors 42 (e.g., 42A, 42C) may be adjusted and/or tuned using any of the embodiments, or a combination of any of the embodiments discussed with respect to FIGS. 8-11, 15-17, and 19-21, to achieve a first combustion dynamics frequency; a second group of the combustors 42 (e.g., 42B, 42D) may be adjusted and/or tuned using any of the embodiments, or a combination of any of the embodiments discussed with respect to FIGS. 8-11, 15-17, and 19-21, to achieve a second combustion dynamics frequency; and a third group of the combustors 42 (not shown) may be adjusted and/or tuned using any of the embodiments, or a combination of any of the embodiments discussed with respect to FIGS. 8-11, 15-17, and 19-21, to achieve a third combustion dynamics frequency. At least two of the first, second, and third combustion dynamics frequencies are different from one another. As a result, the combustion dynamics frequencies associated with the combustors 42 cannot coherently or constructively interfere with one another, reducing or preventing an increase in the combustion dynamics and/or reducing modal coupling and the ability of the combustion system to drive sympathetic vibrations in the downstream turbine section 18.

The commercial and technical advantages of the various embodiments described and illustrated with respect to FIGS. 1-21 may include various advantages over existing combustors 42. For example, reducing the coherence and, therefore, the modal coupling of the combustion dynamics may extend the life of the combustors 42 and/or components downstream from the combustors 42 without unnecessarily limiting the operating range of the combustors 42.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for reducing modal coupling of combustion dynamics in a gas turbine, the system comprising:
a compressor section;
a turbine section downstream of the compressor section;
first and second combustors arranged about an axis between the compressor section and the turbine section, wherein each combustor comprises a cap assembly that extends radially across at least a portion of the combustor, a group of primary fuel nozzles that provides fluid communication through the cap assembly, and a liner that defines a combustion chamber downstream from the fuel nozzles;
each fuel nozzle defining a fuel port that provides fluid communication from the fuel nozzle into the combustion chamber;
a primary fuel circuit comprising a primary fuel manifold and a plurality of fuel supply lines extending from the primary fuel manifold, a first fuel supply line being in fluid communication with the primary fuel nozzle group of the first combustor and a second fuel supply line being in fluid communication with the primary fuel nozzle group of the second combustor;
a first primary orifice plate disposed within the first fuel supply line upstream from the primary fuel nozzle group of the first combustor, the first primary orifice plate defining a first effective area; and
a second primary orifice plate disposed within the second fuel supply line upstream from the primary fuel nozzle group of the second combustor, the second primary orifice plate defining a second effective area substantially different from the first effective area;
wherein the fuel port of the fuel nozzles in the primary fuel nozzle group in the first combustor is located at a first axial distance from the combustion chamber and wherein the fuel port of the fuel nozzles in the primary fuel nozzle group in the second combustor is located at a second axial distance from the combustion chamber, the second axial distance being substantially different from the first axial distance.

2. The system of claim 1, wherein each fuel nozzle comprises a center body having a diameter and an axial length, a burner tube circumferentially surrounding at least a portion of the axial length of the center body, and at least one vane extending radially outward from the center body and being located between the center body and the burner tube, the vane further defining the fuel port at a vane fuel port axial distance from the combustion chamber.

3. The system of claim 2, further comprising, within each combustor, a group of secondary fuel nozzles that provides fluid communication through the cap assembly, each of the secondary fuel nozzles defining at least one vane having a fuel port located at a vane fuel port axial distance from the combustion chamber; wherein the vane fuel port axial distance for the primary fuel nozzles in the first combustor is substantially different from the vane fuel port axial distance for the secondary fuel nozzles in the first combustor.

4. The system of claim 2, wherein the vane fuel port axial distance in the first combustor is substantially different from the vane fuel port axial distance in the second combustor.

5. The system of claim 2, wherein each burner tube in the first combustor defines a first burner tube inner diameter; and wherein each burner tube in the second combustor defines a second burner tube inner diameter substantially different from the first burner tube inner diameter.

6. The system of claim 2, wherein the center body of the primary fuel nozzles in the first combustor defines an additional fuel port at a center body fuel port axial distance from the combustion chamber; and wherein the center body of the primary fuel nozzles in the second combustor defines an additional fuel port at a center body fuel port axial distance from the combustion chamber, the center body fuel port axial distance in the second combustor being substantially different from the center body fuel port axial distance in the first combustor.

7. The system of claim 2, wherein the center body of the primary fuel nozzles in the first combustor defines a first center body diameter; and wherein the center body of the primary fuel nozzles in the second combustor defines a second center body diameter substantially different from the first center body diameter.

8. The system of claim 1, further comprising: a group of secondary fuel nozzles in the first combustor and a group of secondary fuel nozzles in the second combustor, wherein each of the secondary fuel nozzles in the first and second combustors comprises a plurality of bundled tubes, each tube comprising a fuel port to provide fluid communication into each tube, the tube fuel port being located at a tube fuel port axial distance from the combustion chamber.

9. The system of claim 7, wherein the tube fuel port axial distance in the secondary fuel nozzles in the first combustor is substantially different from the tube fuel port axial distance in the secondary fuel nozzles in the second combustor.

10. The system of claim 7, wherein the tubes in the secondary fuel nozzles in the first combustor define a first inner tube diameter and wherein the tube in the secondary fuel nozzles in the second combustor define a second inner tube diameter substantially different from the first inner tube diameter.

11. The system of claim 1, further comprising: a group of secondary fuel nozzles in the first combustor and a group of secondary fuel nozzles in the second combustor;
a secondary fuel circuit comprising a secondary fuel manifold and a plurality of fuel supply lines extending from the secondary fuel manifold, a third fuel supply line being in fluid communication with the secondary fuel nozzle group of the first combustor and a fourth fuel supply line being in fluid communication with the secondary fuel nozzle group of the second combustor;
a first secondary orifice plate disposed within the third fuel supply line upstream from the secondary fuel nozzle group of the first combustor, the first secondary orifice plate defining a third effective area; and a second secondary orifice plate disposed within the third fuel supply line upstream from the secondary fuel nozzle group of the second combustor, the second secondary orifice plate defining a fourth effective area substantially different from the third effective area.

12. The system of claim 11, wherein at least one of the primary and secondary fuel circuits delivers fuel to the first combustor at a first flow rate and wherein at least one of the primary and secondary fuel circuits delivers fuel to the second combustor at a second fuel flow rate substantially different from the first fuel flow rate.

13. The system of claim 11, wherein each fuel nozzle of the primary fuel nozzle group and the secondary fuel nozzle group comprises a center body having a diameter and an axial length, a burner tube circumferentially surrounding at least a portion of the axial length of the center body, and at least one vane extending radially outward from the center body and being located between the center body and the burner tube, the vane further defining the fuel port at a fuel port axial distance from the combustion chamber, wherein the fuel port axial distance for the fuel nozzles of the primary fuel nozzle group is substantially different from the fuel port axial distance for the fuel nozzles of the secondary fuel nozzle group.

14. The system of claim 1, further comprising:
a. a first fuel injector downstream of the first fuel nozzle and a first set of flow openings integrated with the first combustor, the first set of flow openings defining a first collective effective area and the first fuel injector defining a first effective cross-sectional area through the first liner into the first combustion chamber, and
b. a second fuel injector downstream of the second fuel nozzle and a second set of flow openings integrated with the second combustor, the second set of flow openings defining a second collective effective area and the second fuel injector defining a second effective cross-sectional area through the second liner into the second combustion chamber;
wherein the first collective effective area of the first set of flow openings is larger than the second collective effective area of the second set of flow openings and the second effective cross-sectional area is larger than the first effective cross-sectional area.

15. The system of claim 14, wherein the first combustor comprises a plurality of first fuel injectors; and wherein the second combustor comprises a plurality of second fuel injectors different in number from the first combustor.

16. The system of claim 1, wherein the combustor cap assembly defines an axial cap length, the axial cap length in the first combustor being substantially different from the axial cap length in the second combustor.

17. A system for reducing modal coupling of combustion dynamics in a gas turbine, the system comprising:
a compressor section;
a turbine section downstream of the compressor section;
first and second combustors arranged about an axis between the compressor section and the turbine section, wherein each combustor comprises a cap assembly that extends radially across at least a portion of the combustor, a group of primary fuel nozzles that provides fluid communication through the cap assembly, a liner that defines a combustion chamber downstream from the fuel nozzles, a fuel injector located downstream of the primary fuel nozzles, and an outer sleeve at least partially surrounding the liner and defining therethrough a set of flow openings;
the fuel injector defining a first effective cross-sectional area through the liner into the combustion chamber, and the set of flow openings defining a collective effective area;
a primary fuel circuit comprising a primary fuel manifold and a plurality of fuel supply lines extending from the primary fuel manifold, a first fuel supply line being in fluid communication with the primary fuel nozzle group of the first combustor and a second fuel supply line being in fluid communication with the primary fuel nozzle group of the second combustor;
a first primary orifice plate disposed within the first fuel supply line upstream from the primary fuel nozzle group of the first combustor, the first primary orifice plate defining a first effective area; and
a second primary orifice plate disposed within the second fuel supply line upstream from the primary fuel nozzle group of the second combustor, the second primary orifice plate defining a second effective area substantially different from the first effective area;
wherein the collective effective area of a first set of flow openings associated with the first combustor is larger than the collective effective area of a second set of flow openings associated with the second combustor; and
wherein the effective cross-sectional area of the fuel injector in the second combustor is larger than the effective cross-sectional area of the fuel injector in the first combustor.

18. The system of claim 17, wherein the first combustor comprises a plurality of first fuel injectors; and wherein the second combustor comprises a plurality of second fuel injectors different in number from the first combustor.

19. The system of claim 17, further comprising: a group of secondary fuel nozzles in the first combustor and a group of secondary fuel nozzles in the second combustor;
a secondary fuel circuit comprising a secondary fuel manifold and a plurality of fuel supply lines extending from the secondary fuel manifold, a third fuel supply line being in fluid communication with the secondary fuel nozzle group of the first combustor and a fourth fuel supply line being in fluid communication with the secondary fuel nozzle group of the second combustor;
a first secondary orifice plate disposed within the third fuel supply line upstream from the secondary fuel nozzle group of the first combustor, the first secondary orifice plate defining a third effective area; and a second secondary orifice plate disposed within the third fuel supply line upstream from the secondary fuel nozzle group of the second combustor, the second secondary orifice plate defining a fourth effective area substantially different from the third effective area.

20. The system of claim 17, wherein at least one of the primary and secondary fuel circuits delivers fuel to the first combustor at a first flow rate; and wherein at least one of the primary and secondary fuel circuits delivers fuel to the second combustor at a second fuel flow rate substantially different from the first fuel flow rate.

21. The system of claim 17, wherein each fuel nozzle defines a fuel port that provides fluid communication from the fuel nozzle into the combustion chamber; wherein the fuel port of the fuel nozzles in the primary fuel nozzle group in the first combustor is located at a first axial distance from the combustion chamber; and wherein the fuel port of the fuel nozzles in the primary fuel nozzle group in the second combustor is located at a second axial distance from the combustion chamber, the second axial distance being substantially different from the first axial distance.

22. The system of claim 21, wherein each fuel nozzle comprises a center body having a diameter and an axial length, a burner tube circumferentially surrounding at least a portion of the axial length of the center body, and at least one vane extending radially outward from the center body and being located between the center body and the burner tube, the vane further defining the fuel port at a vane fuel port axial distance from the combustion chamber; wherein the vane fuel port axial distance in the first combustor is substantially different from the vane fuel port axial distance in the second combustor.

23. The system of claim 22, wherein each burner tube in the first combustor defines a first burner tube inner diameter; and wherein each burner tube in the second combustor defines a second burner tube inner diameter substantially different from the first burner tube inner diameter.

24. The system of claim 22, wherein the center body of the primary fuel nozzles in the first combustor defines an additional fuel port at a center body fuel port axial distance from the combustion chamber; and wherein the center body of the primary fuel nozzles in the second combustor defines an additional fuel port at a center body fuel port axial distance from the combustion chamber, the center body fuel port axial distance in the second combustor being substantially different from the center body fuel port axial distance in the first combustor.

25. The system of claim 22, wherein the center body of the primary fuel nozzles in the first combustor defines a first center body diameter; and wherein the center body of the primary fuel nozzles in the second combustor defines a second center body diameter substantially different from the first center body diameter.

26. The system of claim 21, further comprising: a group of secondary fuel nozzles in the first combustor and a group of secondary fuel nozzles in the second combustor, wherein each of the secondary fuel nozzles in the first and second combustors comprises a plurality of bundled tubes, each tube comprising a fuel port to provide fluid communication into each tube, the tube fuel port being located at a tube fuel port axial distance from the combustion chamber.

27. The system of claim 26, wherein the tube fuel port axial distance in the secondary fuel nozzles in the first combustor is substantially different from the tube fuel port axial distance in the secondary fuel nozzles in the second combustor.

28. The system of claim 26, wherein the tubes in the secondary fuel nozzles in the first combustor define a first inner tube diameter; and wherein the tube in the secondary fuel nozzles in the second combustor define a second inner tube diameter substantially different from the first inner tube diameter.

29. The system of claim 17, wherein the combustor cap assembly defines an axial cap length, the axial cap length in the first combustor being substantially different from the axial cap length in the second combustor.

30. A system for reducing modal coupling of combustion dynamics in a gas turbine, the system comprising:
a compressor section;
a turbine section downstream of the compressor section;
first and second combustors arranged about an axis between the compressor section and the turbine section, wherein each combustor comprises a cap assembly that extends radially across at least a portion of the combustor, a fuel nozzle that provides fluid communication through the cap assembly, and a liner that defines a combustion chamber downstream from the fuel nozzle;
the fuel nozzle comprising a center body having a diameter and an axial length, a burner tube circumferentially surrounding at least a portion of the axial length of the center body, and a fuel port that provides fluid communication from each fuel nozzle into the combustion chamber;
wherein the center body defines a center body diameter and wherein the burner tube defines a burner tube inner diameter; and
wherein at least one of the center body diameter and the burner tube inner diameter in the first combustor is substantially different along at least a portion of a length thereof from the respective center body diameter and burner tube inner diameter in the second combustor.

31. The system of claim 30, wherein both the center body diameter and the burner tube inner diameter in the first combustor are substantially different from the center body diameter and the burner tube inner diameter in the second combustor.

32. The system of claim 30, wherein the burner tube inner diameter in the first combustor is substantially different from the burner tube inner diameter in the second combustor; and wherein a at least one vane extends radially outward from the center body and is located between the center body and the burner tube, the vane further defining the fuel port at a vane fuel port axial distance from the combustion chamber, the vane fuel port axial distance in the first combustor being substantially different from the vane fuel port axial distance in the second combustor.

33. The system of claim 30, wherein the center body of the primary fuel nozzles in the first combustor defines an additional fuel port at a center body fuel port axial distance from the combustion chamber; and wherein the center body of the primary fuel nozzles in the second combustor defines an additional fuel port at a center body fuel port axial distance from the combustion chamber, the center body fuel port axial distance in the second combustor being substantially different from the center body fuel port axial distance in the first combustor.

34. The system of claim 30, wherein the center body of the primary fuel nozzles in the first combustor defines a first center body diameter; and wherein the center body of the primary fuel nozzles in the second combustor defines a second center body diameter substantially different from the first center body diameter.

35. The system of claim 30, further comprising: a group of secondary fuel nozzles in the first combustor and a group of secondary fuel nozzles in the second combustor, wherein each of the secondary fuel nozzles in the first and second combustors comprises a plurality of bundled tubes, each tube comprising a fuel port to provide fluid communication into each tube, the tube fuel port being located at a tube fuel port axial distance from the combustion chamber.

36. The system of claim 35, wherein the tube fuel port axial distance in the secondary fuel nozzles in the first combustor is substantially different from the tube fuel port axial distance in the secondary fuel nozzles in the second combustor.

37. The system of claim 35, wherein the tubes in the secondary fuel nozzles in the first combustor define a first inner tube diameter and wherein the tube in the secondary fuel nozzles in the second combustor define a second inner tube diameter substantially different from the first inner tube diameter.

38. The system of claim 30, wherein the combustor cap assembly defines an axial cap length, the axial cap length in the first combustor being substantially different from the axial cap length in the second combustor.
